(19) United States
(12) Patent Application Publication
(10) Pub. No.: US 2023/0062419 A1
(43) Pub. Date: Mar. 2, 2023

(54) MULTI-DIMENSIONAL LIGAND-ASSISTED CHROMATOGRAPHY METHOD FOR THE PURIFICATION OF COMPLEX REE AND OTHER METAL IONS FORM MIXTURES/MINERALS

(71) Applicant: Purdue Research Foundation, West Lafayette, IN (US)

(72) Inventors: Nien-Hwa Linda Wang, West Lafayette, IN (US); David Harvey, West Lafayette, IN (US); Yi Ding, West Lafayette, IN (US)

(21) Appl. No.: 17/797,822

(22) PCT Filed: Jan. 28, 2021
(86) PCT No.: PCT/US2021/015364

§ 371 Date: Aug. 5, 2022

Related U.S. Application Data
(60) Provisional application No. 62/982,811, filed on Feb. 28, 2020.

(51) Int. Cl. B01D 15/42; B01D 15/38; B01D 15/18; C22B 59/00; C22B 3/24

(52) U.S. Cl. CPC B01D 15/422; B01D 15/1864; B01D 15/3828; C22B 3/24; C22B 59/00

(57) ABSTRACT

A method for separating substantially pure rare earth metals and other metals from a mixed source, including putting a plurality of rare earth metals and other metals into solution to define a solution containing a plurality of respective metal ions, in at least one chromatographic column, selectively capturing ions of each respective metal with a respective ligand to define a plurality of respective discrete bands, and respectively eluting captured ions of respective metal from each respective band of the at least one chromatographic column to yield a plurality of purified solutions, each respective purified solution having a high concentration of a respective metal. The bands may either be stationary with respect to the columns, or may move through the columns.

### GOVERNMENT FUNDING

This invention was made with government support under SP8000-18-P-0007 awarded by the Defense Logistics Agency. The government has certain rights in the invention.

### CROSS-REFERENCE TO RELATED APPLICATIONS

This patent application claims priority to co-pending U.S. Provisional Pat. Application Serial No. 62/982,811, filed on 28 Feb. 2020.

### TECHNICAL FIELD

The present novel technology relates generally to the field of chemical engineering, and, more particularly, to a method of recovering the rare earth elements from ores and other sources.

### BACKGROUND

The supply chain of Rare Earth elements (REES) is often at risk because the production of REEs is highly concentrated in just a few countries and regions around the world. Even though United States has one of the most productive REEs mines (Mountain Pass, CA) in the world, no pure REEs are produced in the US. The conventional liquid-liquid extraction methods for REEs purification are inefficient and produce large amounts of waste. US producers cannot use the conventional methods and compete with China in producing REEs at similar costs because of strict environmental regulations. Thus, there is a need for a means for extracting REEs from raw materials that is both cost effective and environmentally friendly. The present novel technology addresses this need.

### SUMMARY

A chromatography separation method for purifying REEs from raw sources, such as ores and minerals, has been developed. A versatile design method for the purification of rare earth metals from REE crude derived from recycled sources or the like was implemented for the separation of REE mixtures with a plurality of components. REE feed mixtures derived from minerals and/or recycled materials often have widely different REE compositions. The productivity would be limited by achieving high yield for a minor component in the feed mixture if a single column is used. Instead, multiple zones may be employed to achieve high purity, high yield, and high productivity for all components. The selectivity weighted composition factor y is useful to precisely split the major components with high productivity in the first zone and subsequent zones. The mixed bands may be further separated to split into binary pairs. In the final zone, a mixed band of binary mixture may be recycled and combined with the binary feed without affecting productivity allowing the overall yield to be improved to greater than 99%.

The present novel technology relates to a novel ligand-based chromatography (LBC) zone-splitting method developed for producing high-purity (>99%) rare earth metals, as well as some other elements, with high yields (>99%) and high sorbent productivity from crude REE mixtures derived from mineral ores and/or waste materials. Ligands with selectivity for REEs may be added in the mobile phase to enable ligand assisted displacement (LAD) wherein the REEs are recovered during a ligand-assisted elution (LAE) step, or the ligands may be immobilized on a stationary phase to enable a ligand-bound displacement (LBD) with a continuous elution mode (LB-SMB).

Ligands with affinity for one or more REEs include citric acid, aminopolycarboxylic acids (such as ethylenediaminetetraacetic acid (EDTA), diethylenetriaminepentaacetic acid (DTPA), nitrilotriacetic acid (NTA), and the like), bicine, and the like, as well as other REE selective extractants such as HDEHP, DGA, and the like.

The new method introduces a multi-zone ligand-assisted displacement chromatography (LAD) system with an improved correlation for predicting the minimum column length to reach a constant-pattern state in LAD. The zone-splitting method based on selectivity-weighted composition factors enables a two-zone design to achieve two orders of magnitude higher productivity than that of a single column design. The design and simulation methods are based on first principles and intrinsic (or scale-independent) engineering parameters. They can be used to design processes for a wide range of feed compositions or production scales. The overall productivity of the multi-zone LAD can exceed 100 kg REEs/m3/day, which is 100 times higher than those of the conventional extraction methods.

In the case of LDA, sorbents include microporous, sulfonic acid, aminophosphoric acid functional groups, and the like. For LBD, sorbents IDA resin has a high selectivity for Cu, Ni, Co but low selectivity for REEs; porous silica with bound EDTA, DTPA, and/or phosphate ligands, DGA bound on PMMA, and EDTA bound on PS or polymeric resins with amine functional groups.

The LAD and/or LBD for the purification of the ternary mixture requires only three chromatography columns, a safe extractant, EDTA, and other environmentally friendly chemicals. Most of the chemicals can be recycled, generating little waste. This method has the potential for efficient and environmentally friendly purification of the REEs from waste magnets. The method may also help transform the current linear REE economy (from ores to pure REEs, to products, to landfills) to a circular and sustainable REEs economy.

The design method was tested in the first example using a mixture of seven REEs with similar concentrations. The simulation elution profiles matched closely with the experimental results, validating the accuracy of the intrinsic parameters and the rate model simulations. Then, a bastnasite simulant mixture with six REEs was also tested in a second example. High purity (>99%) Ce and La were recovered with relatively high productivity (in excess of 100 kg/m³/day).

In another example, a light REEs fraction was separated with high yield, high purity, and high productivity using a three-zone design. Ce and La with high y values were separated with high productivity in the first zone, the mixed band of Nd/Pr/Ce were collected and split into two binary pairs in the second zone and pure Nd and Pr were recovered in the third zone. To achieve 99% yield and >99% purity in this three-zone design, the overall productivity was three order of magnitude higher than that in a single column. The overall productivity was more than 100-fold higher than the conventional extraction method.

The multi-zone LAD design can effectively recover high purity individual REEs from minerals. The high productivity of multi-zone LAD leads to much more compact process volume than the extraction method. Instead of using a large amount of organic solvents, highly concentrated acids and ammonium salts, and highly toxic extractant, only a benign EDTA solution is used in LAD. No acidic wastewater is discharged. More than 95% of the chemicals can be recovered and reused, generating little waste.

### DESCRIPTION OF THE DRAWINGS

FIGS. 1A-1D graphically illustrate REE concentrations and composition of bastnasite concentrate (left) and monazite concentrate (right) with >50 wt. % REO content.

FIG. 2A schematically illustrates the constant-pattern chromatography method of recovering rare earth elements from a mixture.

FIG. 2B schematically illustrates an overview of multi-zone constant-pattern design; in the constant pattern correlation map, for the design of Zone I, the correlation shown in solid curve is used; for the design of zones after Zone I, the correlation shown in dashed curve is used.

FIG. 3 is a graph of UV-V spectra of different EDTA-REE complex.

FIG. 4 is a graph of LAD separation of 7 REEs in a synthetic mixture in a single chromatographic column, with solid curves representing experimental elution profiles and dashed curves representing simulated elution profiles; dotted curve is the pH of the effluent.

FIG. 5 is a graph of elution profiles of 6 REEs in a bastnasite simulant and comparison with VERSE simulated profiles.

FIG. 6 schematically illustrates A three-zone design scheme for the separation of the light fraction with four REEs, Nd, Pr, Ce, and La. Zone I aims to recover a majority of Ce and La as high purity products; the minor components, Nd and Pr are not separated and are collected in the mixed band together with Ce; the mixed band of Nd/Pr/Ce and Ce/La is further separated in Zone II; Nd/Pr/Ce are split into two binary pairs and separated into pure fractions in two columns in Zone III; Ce/La are separated into pure fractions in Zone II Column B.

FIG. 7 is a graph of the elution profile of Zone I in light fraction separation.

FIG. 8 is a graph of the elution profile for light fraction separation in Zone II, with the dashed curves representing simulations and the solid curves representing data from the PDA detector.

FIG. 9 schematically illustrates a three-zone LAD design for recovering Nd, Pr, Ce, and La from bastnasite light fraction.

FIG. 10A graphs the elution profile of Zone I for LBD separation of La, CE, Pr, and Nd from bastnasite light fraction using 3 zones and 4 columns.

FIG. 10B graphs the elution profile of Zone II for LBD separation of La, CE, Pr, and Nd from bastnasite light fraction using 3 zones and 4 columns.

FIG. 10C graphs the elution profile of Zone III-A for LBD separation of La, CE, Pr, and Nd from bastnasite light fraction using 3 zones and 4 columns.

FIG. 10D graphs the elution profile of Zone III-B for LBD separation of La, CE, Pr, and Nd from bastnasite light fraction using 3 zones and 4 columns.

FIG. 11 graphically illustrates a campaign schedule for producing 100 kg of REEs from the light fraction of Bastnasite using a lab-scale column (10 cm ID and 100 cm length) for sequential operation of the three zones; the average productivity for the tandem 3-zone design shown in FIG. 6, 66877 is similar to this sequential operation.

FIG. 12 schematically illustrates a two-zone design with two columns for recovering Pr/Nd from light fraction derived from bastnasite using LBD.

FIG. 13A graphs the elution profile of Zone I for LBD separation of Nd/Pr from bastnasite light fraction.

FIG. 13B graphs the elution profile of Zone II for LBD separation of Nd/Pr from bastnasite light fraction.

FIG. 14 schematically illustrates a one-zone design with two columns for recovering Eu/Gd/Sm from light fraction derived from bastnasite using LBD.

FIG. 15 graphs the elution profiles for recovering Sm/Eu/Gd from HREEs derived from bastnasite using LAD; experimental results are solid lines; simulation results are dashed lines.

FIG. 16 schematically illustrates a two-zone design for recovering Pr/Nd, HREE from light fraction derived from bastnasite using LBD.

FIG. 176A graphs the elution profile of Zone I for LBD separation and recovery of Pr/Nd and heavy rare earth elements from monazite.

FIG. 17B graphs the elution profile of Zone I-AI for LBD separation and recovery of Pr/Nd and heavy rare earth elements from monazite.

FIG. 17C graphs the elution profile of Zone II-B for LBD separation and recovery of Pr/Nd and heavy rare earth elements from monazite.

FIGS. 18A-C graphs the elution profiles for recovering La/Ce/Pr/Nd from HREEs derived from bastnasite using LAD.

FIG. 19 schematically illustrates a first splitting strategy.

FIG. 20 schematically illustrates a second splitting strategy.

FIG. 21 schematically illustrates a third splitting strategy.

FIG. 22 schematically illustrates a fourth splitting strategy.

### DETAILED DESCRIPTION

For the purposes of promoting an understanding of the principles of the invention and presenting its currently understood best mode of operation, reference will now be made to the embodiments illustrated in the drawings and specific language will be used to describe the same. It will nevertheless be understood that no limitation of the scope of the invention is thereby intended, with such alterations and further modifications in the illustrated device and such further applications of the principles of the invention as illustrated therein being contemplated as would normally occur to one skilled in the art to which the invention relates.

In 2018, China accounted for about 80% of global rare earth production. The light REEs (La, Ce, Pr, Nd, Sm) are mainly produced from bastnäsite and monazite in northern China. Because there are few heavy REEs ores outside China, all the heavy REEs (Eu, Gd, Tb, Dy, Ho, Er, Tm, Yb, Lu) are currently produced from the ion-adsorption clays in southern China. These REEs are produced at low costs, because of low wages and loose environmental regulations. Outside China, the majority of REEs production comes from Mount Weld deposit in Australia, which produces mainly light REEs.

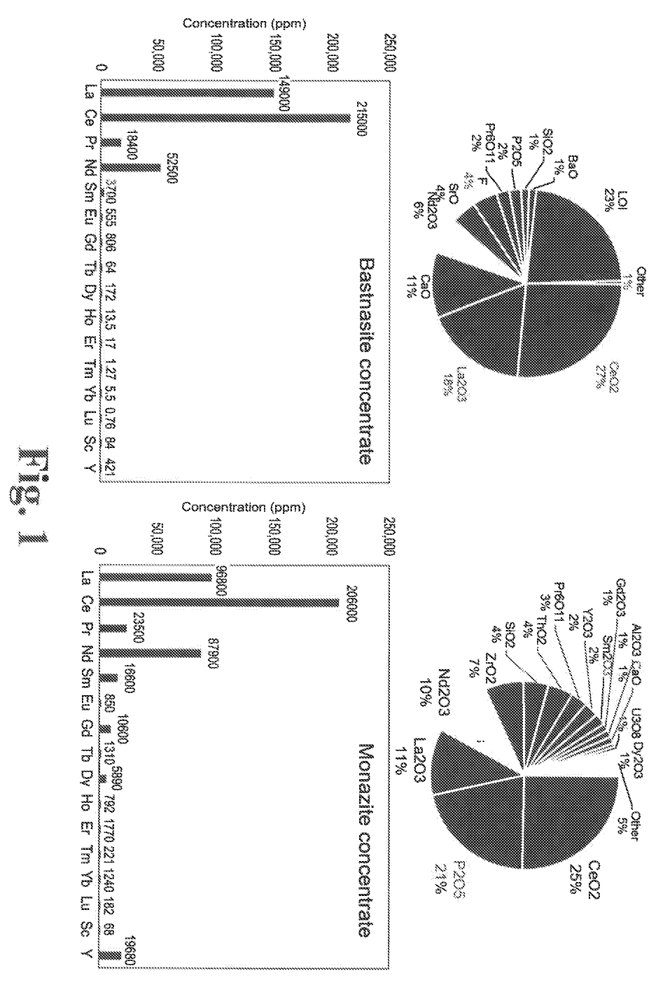

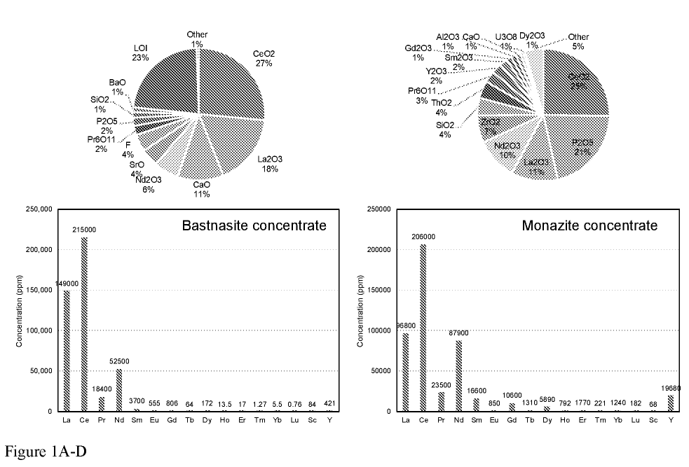

The U.S. is estimated to have a rare earth mine reserve that is equivalent to 1,400,000 tons of rare earth oxide, with a majority 90% in Bastnasite and some Monazite. The U.S. has one of the largest REEs deposit in the world in Mountain Pass, California. The bastnäsite in Mountain Pass is rich in light REEs including La, Ce, Pr and Nd, which account for about 99% of the total REEs. The U.S. production of REEs stopped in 2015 due to the mine operators filing for bankruptcy. Prior to then , the was quite productive. While production eventually stopped in 2015, at least one of these mines re-opened in 2018, when 15,000 tons REO equivalent of bastnäsite concentrate (FIG. 1) were produced and sent to China for further purification. No purified rare earth elements have been produced in the U.S. after 2015.

The supply of REEs in the U.S. is quite dependent on imports from China, Estonia, France, and Japan. The production of rare earth elements is highly concentrated in a few countries around the world, posing great supply risks and limiting the development of high-tech industries in other countries. The production of REEs has been limited by a variety of factors. The lack of technical expertise, the issues associated with the radioactive wastes produced as byproduct of REE extraction, and high capital cost for a new REEs production plant using conventional production and separation methods (up to one billion dollars) all chilled the development of a United Stages supply.

Rare earth elements are actually not “rare”; they are more abundant than many other elements in the Earth crust. This misnomer results from a dispersive distribution of rare earth elements. Unlike other metal elements that have stable and concentrated minerals, typical REE ores contain only a few percent rare earth elements or even less, and they often occur as a group. The production of the REEs usually starts from the beneficiation and concentration of the ores. For example, one of the major REE source, bastnäsite, a rare earth fluorocarbonate mineral, containing about 7-8% of rare earth oxide (REO) equivalent. After crushing and grinding, chemical steam conditioning, flotation, and cleaning, the ores can be upgraded to an REE concentrate that contains about 60% of REO for further digestion, purification and refining. The non-REE components, including thorium and uranium, were further removed by precipitation. The light REEs can then be separated from the heavy REEs using liquid-liquid extraction and precipitated by ammonium carbonate.

The purification after chemical digestion, is the most difficult step because of the similar physical and chemical properties of REEs that are present all together in the crude feed. Current industrial purification still uses the liquid-liquid extraction method developed in the 1950’s, which involves thousands of mixer-settler units to produce high-purity REEs. The liquid-liquid extraction method is difficult to adopt for different feedstocks or different scales. Also, it is energy intensive, requiring the use of organic solvents, acidic stripping agents, and toxic extractants, generating a large amount of acidic and toxic waste. To produce 1 ton of REO, more than 2 tons of base and 10 tons of acid are consumed, and more than 120 tons of wastewater is discharged. The extraction separation process also consumes a large amount of ammonia for saponification of the organophosphorus extractant, as well as a large volume of hydrochloric acid in the stripping reaction. Only 35% of the ammonia was recovered as ammonium chloride on average in the process. Life cycle analysis studies revealed that the conventional purification process could account for about ⅓ of the total environmental impacts in terms of global warming, carcinogen and non-carcinogen human toxicity, and eutrophication and ecotoxicity. Furthermore, it contributes to 70% of the impact in terms of ozone depletion. Because of strict environmental regulations in the US, it is difficult to use the liquid-liquid extraction method for producing purified REEs at similar costs as in China.

The instant novel technology offers an efficient, economical, and environmentally friendly ligand-assisted displacement chromatography method to enable the production of high-purity REEs in the United States. This novel technology demonstrates: (1) a design method to produce high-purity REEs with high yield and high sorbent productivity from complex REE mixtures; (2) application of the design method for different REE feedstocks with different compositions and different production scales. The specific results discussed below include the following: (1) test the constant pattern design method using a synthetic mixture of seven REEs with similar concentrations and compare the chromatograms with simulations; (2) test the design method using a simulant of Bastnasite concentrate with 6 REEs and compare the chromatograms with simulations; (3) design a three-zone LAD and test the design method with the Light REE fraction from Bastnasite (Ce, La, Nd, and Pr) provided by MP Materials, and demonstrate the advantages of high purity, high yield, and high sorbent productivity of the multi-zone method.

Herein, it is established that first, analytical methods are employed to determine the REE concentrations in aqueous solution by using a photodiode array detector and inductively coupled plasma optical emission spectroscopy. Next, the multi-zone REE recovery method and the simulation model were verified by the physical separation of 7 “visible” REEs from a starting solution. A simulant with similar composition to bastnasite was then separated with minor components grouped together and pure Ce and La fractions were collected. The constant-pattern design method was then modified and improved into a multi-zone design for the separation of a four-component mixture derived from a light REEs fraction with four components. In the experimental examples, high purity La, Ce and Nd were recovered. A theoretical design was developed for the light REE fraction targeting >99% yield and >99% purity for all component. Compared to single column LAD systems, the multi-zone design can achieve three orders of magnitude higher productivity.

### Theory

A constant-pattern design method of LAD for REE purification has been developed. This method involves ion exchange columns with a ligand in the mobile phase to substantially increase the selectivity. The column length and fluid velocity needed for the formation of a constant pattern state are determined from intrinsic adsorption, mass transfer, and ligand-solute complexation parameters. This allows for a robust and reliable design method for achieving high-purity, high-yield separation with high sorbent productivity. The 1,800 mixer-settler units in liquid-liquid extraction can be replaced with a few chromatography columns with 100 times smaller volume and one tenth the footprint and capital cost. Most processing chemicals are benign and can be recycled, generating little waste. This method holds a great promise for producing sufficient quantities of REEs domestically from bastnäsite, coal fly ash, waste magnets, and many other REE sources.

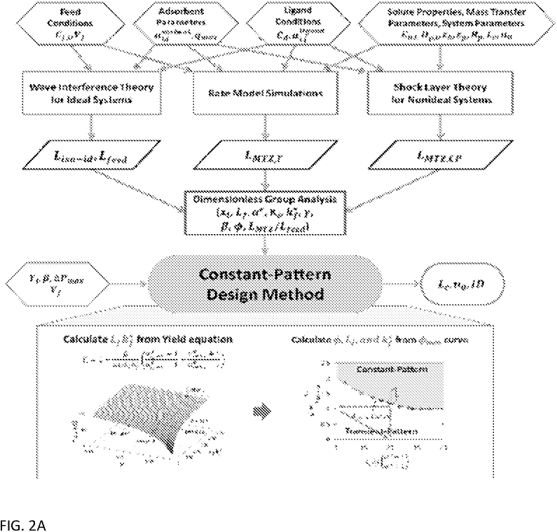

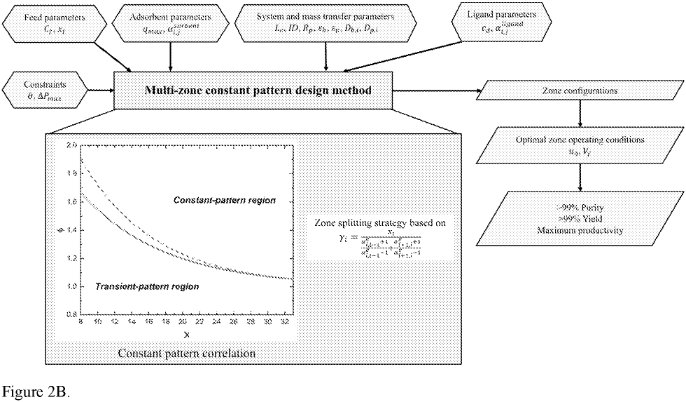

A novel general splitting strategy has been developed for varied and complex REE mixtures that divides the separation between multiple zones. Utilizing this “divide and conquer” strategy, the overall productivity is increased by orders of magnitude compared to single column systems. A brief summary of the method is given in FIG. 2. Application of this design method for the separation of multi-component REE mixtures are explained below in the examples.

An advantage of the present novel technology is the ability to handle a variety of feedstocks using multiple separation zones. In the first zone, a feed mixture of REE ions is typically loaded in an aqueous solution. The sorbent has negligible selectivity for different REEs. Hence, the feed will form a uniform band near the entrance of the column with no separation. The separation occurs after the ligand solution is introduced into the column. When free REE ions are loaded onto the column and a uniform band near the entrance of the column is formed, the minimum column length required to form a constant pattern can be calculated using Eq. (1) (See FIG. 2 solid line).

$$ϕ = 1 + 1.5 {e}^{- \frac{X}{9.8}}$$

However, in subsequent zones the feed is a mixture of ligand-bound REEs obtained from the previous zones. When these mixtures are loaded into a presaturant (for example, with presaturant Cu²⁺) saturated column, separation will begin during the loading. For this type of feed, the calculation method for the minimum required column length in an ideal system to form an isotachic train is different. For this reason, a new general correlation Eq. (2) and a new general map was developed for LAD systems in which separation begins during feed loading (See FIG. 2 dashed line).

$$ϕ = 1 + \frac{7.2}{X}$$

### Analytical Method of Rare Earth Elements in the Column Effluent

The rare earth elements were separated using ligand-assisted displacement (LAD) and/or ligand-bound displacement (LBD) chromatography. REEs in the effluent were in the form of EDTA-REE complexes. Accurate analytical methods were developed to analyze column effluents to establish the elution profiles.

### UV-Vis Spectra of EDTA-REE Complex

Online detection of EDTA-REEs using a photo-diode array detector (PDA) is a relatively straightforward method of determining the REE concentrations in column effluent. Many REEs in the lanthanide series have UV-Vis absorbance at different wavelengths. However, some of the REE ions have major absorbance peaks at wavelengths below 350 nm, which overlap with the peaks of EDTA in the effluent. The analytical method of using a PDA detector was developed first. A small pulse of various EDTA-REE complex was injected into the detector and the online spectra were recorded and exported from the detector.

### ICP-OES Analysis of Rare Earth Elements

The concentration of REEs that cannot be analyzed using the online PDA detector needs another elemental analysis method. Inductively coupled plasma optical emission spectroscopy (ICP-OES) is the best elemental analysis method for determining REE concentrations in the ppm range. The effluent from the column was collected using an Agilent LC-440 fraction collector and then sent to ICP analysis.

### Dissolution of Mountain Pass Light REE Fraction

About 15 g of light carbonate fraction was weighted into a beaker. Then 200 ml of 1 M HC1 was poured into the beaker, generating carbon dioxide bubbles. The mixture was then stirred overnight, and a clear solution without any solid residue was obtained. The solution was then poured into a 250-ml volumetric flask. The concentration of REEs in the solution was determined using ICP-OES.

### Ligand-Assisted Displacement Chromatography

The column was first saturated by copper ions by loading a copper sulfate or copper chloride solution into the column. The column was then washed using two column volumes of water to remove excess copper in the particle pores or the column void space. Then the feed mixture was loaded into the column. Two column volumes of water was then used to flush the column to ensure that all the REEs in the feed were adsorbed and to remove any remaining H⁺ from the acid dissolution step (for the LREE crude). The separation started when the ligand solution was introduced into the column. The effluent was monitored using an on-line PDA detector for detecting visible REE elements. Effluent fractions were also collected for further elemental analysis using ICP-OES.

### Trade-Off Curve Between Yield and Productivity for a Complex Mixture With a Minority Component

If a single column is used for producing a product with a desired purity, there is a trade-off between yield and productivity. To increase the yield of a target component, a slow mobile phase velocity is required to sharpen the waves and reduce the lengths of the overlapping regions with the adjacent bands. However, the slow velocity results in a small sorbent productivity. If a high velocity is used to increase sorbent productivity, the waves are more spread and the lengths of the overlapping regions increase, resulting in a lower yield. This relation between yield and productivity is known as the “trade-off” curve for a single column.

Generally, if a single column is used for the recovery of a single component from a complex mixture, the product purity is controlled by the breakthrough cut θ and the yield of the target component. The sorbent productivity is controlled by a selectivity-weighted composition factor γi, defined in Eq. (2).

$${γ}_{i} = \frac{{x}_{i}}{\frac{{α}_{i , i - 1}^{e} + 1}{{α}_{i , i - 1}^{e} - 1} + \frac{{α}_{i + 1 , i}^{e} + 1}{{α}_{i + 1 , i}^{e} - 1}}$$

The yield Yᵢ and the sorbent productivity P_{R,i} are related to the _{Yi} values by Eq. (3) and Eq. (4):

$${Y}_{i} = 1 - \frac{β}{2 {γ}_{i} {L}_{f} {k}_{f}^{∗}}$$

$${P}_{R , i} = \frac{{ε}_{b} {c}_{d} {u}_{0} {x}_{i} {L}_{f}}{{L}_{c}} \left(1 - \frac{β}{2 {γ}_{i} {L}_{f} {k}_{f}^{∗}}\right)$$

where _{Xi} is the mole fraction of component i in the feed mixture; β is the natural logarithm of the ratio of (1 - θ) to θ, where θ is the breakthrough cut;

$${α}_{i , i - \text{1}}^{e}$$

is the selectivity between component i and the component eluting ahead of component i;

$${α}_{i + 1 , i}^{e}$$

is the selectivity between the component eluting after component i and component i; ε_{b} is the bed void fraction; c_{d} is the effective ligand concentration, u₀ is the linear interstitial velocity of the mobile phase; and L_{c} is the column length,

For an equimolar mixture, where _{Xi} is the same for all components, the component i with the highest selectivities will have the narrowest mixed band regions between its two adjacent bands. This component will have the highest value of γᵢ, the highest yield, and the highest productivity.

For a complex mixture, if the selectivity between each pair of the adjacent components was the same, the constant-pattern mass transfer zone length would be the same for all solute bands. As _{Xi} increases, the displacement band becomes wider. The component with the highest mole fraction has the highest yield, because the overlapping region relative to total displacement band width is the smallest, and the yield loss due to the mixed band relative to total amount is the smallest. The component with the largest _{Xi} value or the largest γᵢ value has the highest yield and the highest productivity.

Therefore, the selectivity-weighted composition factors _{Yi} account for the effects of composition and selectivity. The component with the largest _{Yi} value can be separated from a mixture with the highest productivity using a single column.

If a single column is used to recover all three components with high yields and high purities from the mixture, the velocity or flow rate is limited by the yield requirement for the component with the smallest _{Yi} value. If the design aims to recover that component with 95% yield, the productivities of the remaining components are also small because of the low velocity.

However, if the separation of a plurality of REEs occurs in two or more separate zones, one can recover high-purity REEs with high yield and high productivity. A systematic splitting strategy is developed. The component with the largest _{Yi} value is recovered first with a high purity and high productivity in Zone I. The mixed bands of Zone I containing combination sof other REES are then sent to the next zone (Zone II) for further separation. The mixed band material in Zone II is then recycled to the inlet of Zone II to achieve high yields (99%) for all components. In this method, the productivity and the yield of each component are no longer limited by the trade-off curves for a single column. The overall productivity of a two-zone design with high purity (>99.5%) and high yield (>99%) for a three REE mixture is more than 100 times higher than that of the single column design with similar product purity and 95% yield a primary component.

### Example 1- Separation of 7 “Visible” REEs in a Synthetic Mixture

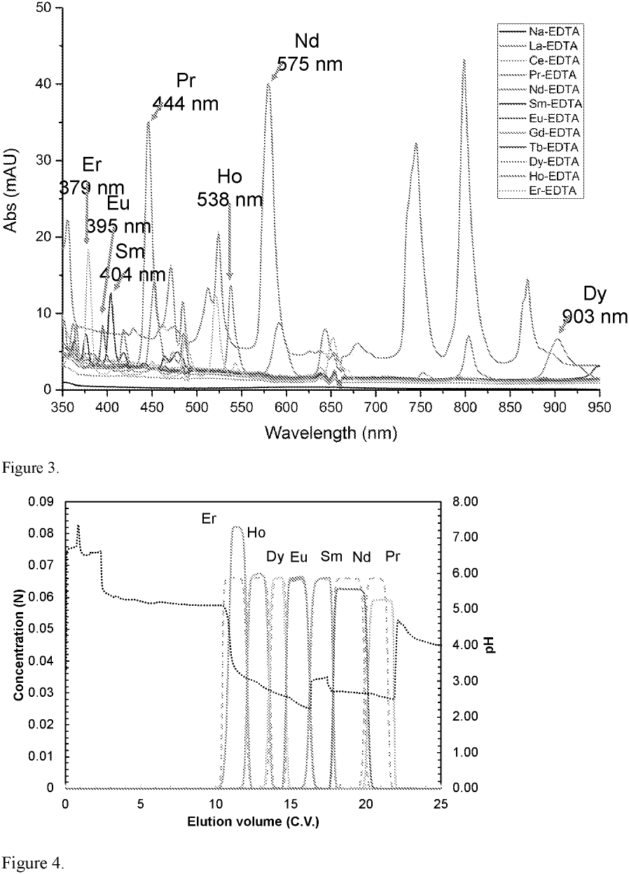

From the experimental spectra, it was found that La, Ce, Gd, and Tb could not be detected using the PDA detector. Although the free ions of Ce, Gd, Tb were reported in literature to be detectable in an aqueous solution, their EDTA complexes were masked by EDTA because their absorption wavelengths were below 350 nm. Seven elements, Pr, Nd, Sm, Eu, Dy, Ho and Er, were detectable using a PDA detector without interference of EDTA (FIG. 3). Most of the wavelengths chosen in our study were close to the literature values for free ions, except for Er, which was reported to have absorbance at 523.5 nm. We did find the absorption peak at this wavelength, but it overlapped with the peak of Nd. Although these two elements did not form adjacent displacement bands in LAD, another wavelength, 379 nm, was chosen for the detection of Er.

Table 1

Wavelengths for Detecting EDTA-REEs Complex and Literature Wavelengths for Detecting REEs Without EDTA

| Elements | Literature Wavelength (nm) (Free REE³⁺ ions) | Experimental Wavelength (nm) (EDTA Complex) |
|---|---|---|
| La | | |
| Ce | 253 | |
| Pr | 444.0 | 444 |
| Nd | 575.5 | 575 |
| Sm | 401.6 | 404 |
| Eu | 394.3 | 395 |
| Gd | 272.7 | |
| Tb | 219.0 | |
| Dy | 911.0 | 903 |
| Ho | 536.5 | 538 |
| Er | 523.5 | 379 |

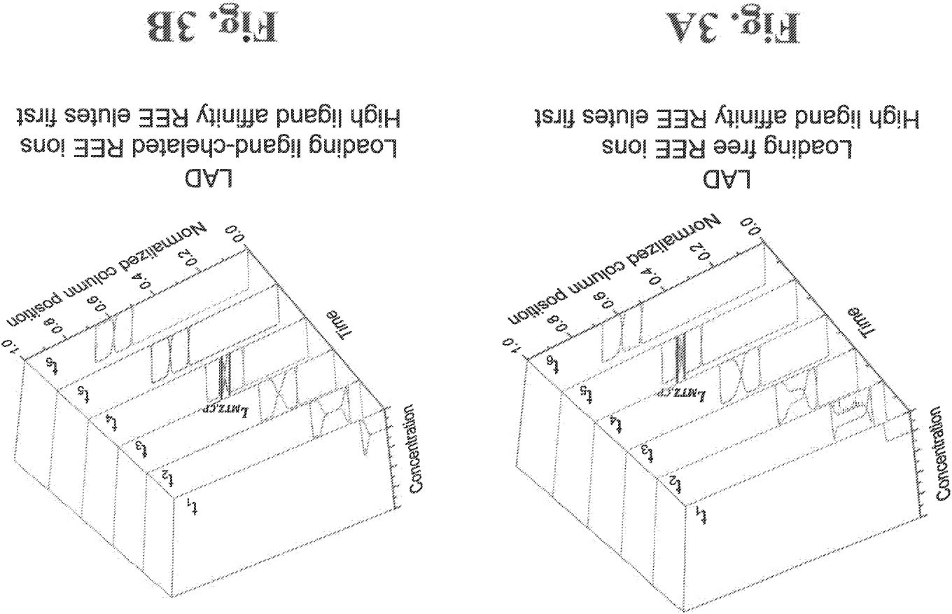

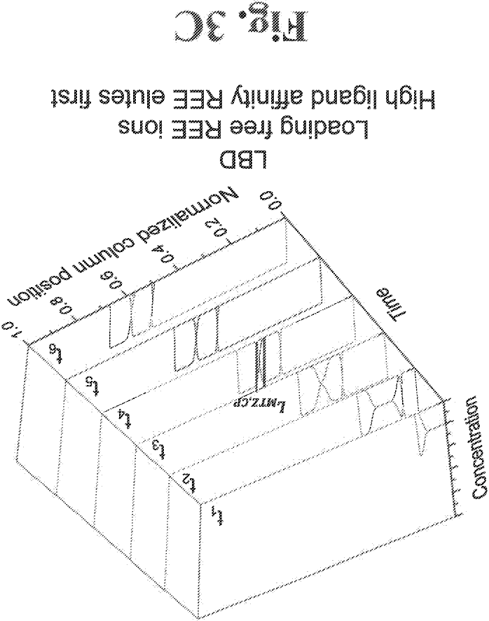

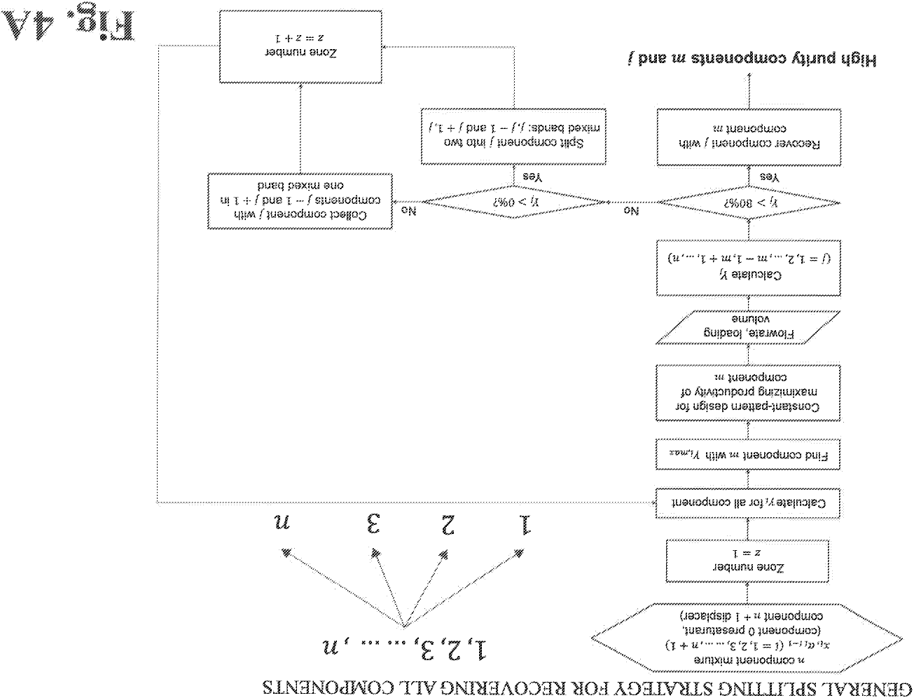

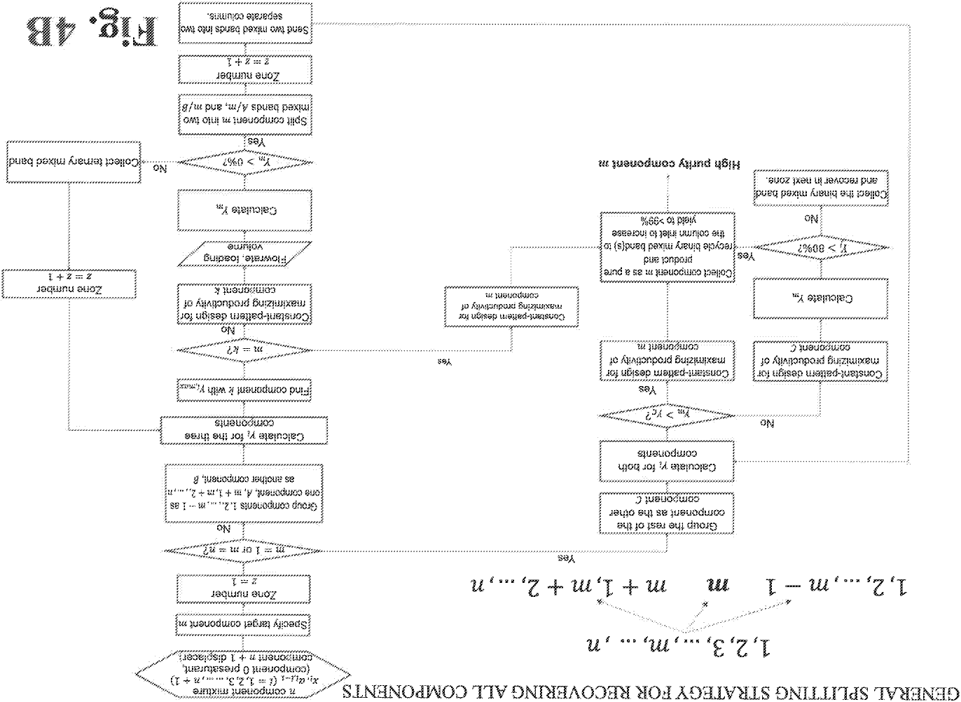

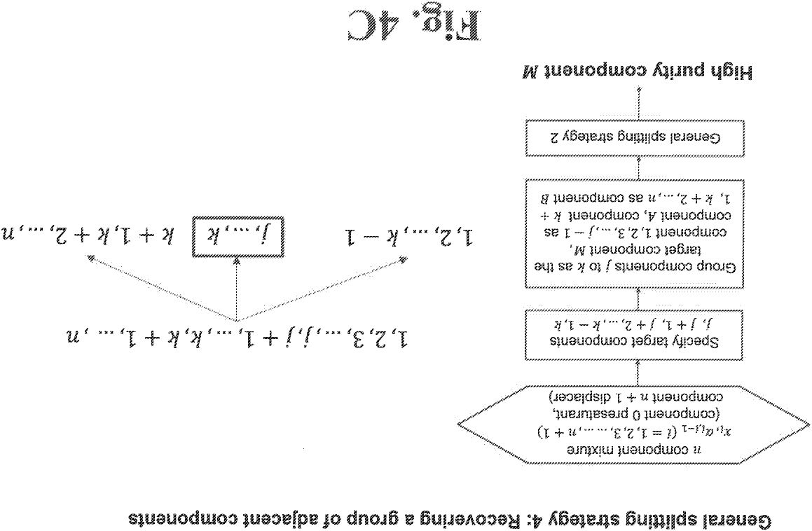

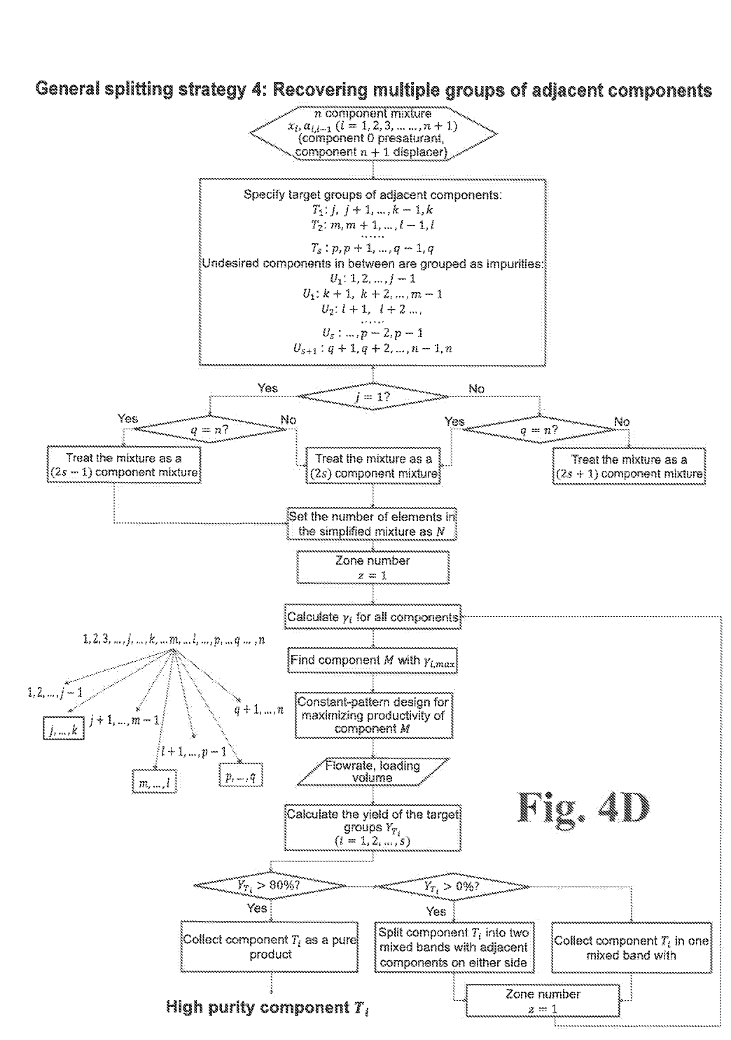

A mixture with seven visible REEs with similar concentrations (Table 2) were separated using ligand-assisted displacement chromatography. The elution profiles are compared with simulations in FIG. 4. The yields and purity of the LAD separation are listed in Table 3.

Table 2

Experimental Parameters for the Separation of Seven Visible REEs

| L (cm) | ID (cm) | R (µm) | ε_{b} | εp | Feed volume (ml) | Component | Concentration(N) |
|---|---|---|---|---|---|---|---|
| 85 | 1.16 | 63 | 0.36 | 0.3 | 207 | Pr | 0.05 |
| | | | | | | Nd | 0.066 |
| | | | | | | Sm | 0.05 |
| | | | | | | Eu | 0.05 |
| | | | | | | Dy | 0.034 |
| | | | | | | Ho | 0.05 |
| | | | | | | Er | 0.05 |

Table 3

The Experimental Purity and Yield of the Individual REEs in the LAD Separation

| Elements | Yield (%) | Purity (%) |
|---|---|---|
| Er | 63.46 | 99.43 |
| Ho | 70.14 | 99.32 |
| Dy | 65.84 | 99.40 |
| Eu | 72.12 | 99.61 |
| Sm | 70.93 | 99.31 |
| Nd | 83.61 | 99.66 |
| Pr | 85.70 | 99.50 |

The results in FIG. 4 show close agreement of the simulated and the experimental elution profiles of Ho, Dy, Eu, and Sm. The deviation of Er was likely because of UV-Vis signal deconvolution error, as the Er signal was partially masked by the Cu absorbance. The decreasing band concentration during Nd and Pr elution could result from a decreasing ligand pH, since the experiment last for more than one day and the basic ligand solution could absorb some CO₂ from air, resulting in a lower pH. The ligand efficiency is lower at a lower pH, resulting the wider and less concentrated Nd and Pr bands toward the end of the LAD process.

### Example 2- Separation of REEs in a Bastnasite Simulant Mixture

A synthetic mixture of six REEs La, Ce, Pr, Nd, Sm, and Gd with similar composition to the bastnäsite concentrate was separated in a single column using the constant-pattern LAD design method. Sm and Gd were added to the mixture to model the trace elements. The ligand used in this test was 0.03 M EDTA at pH=10.45. This ligand concentration and pH result in an effective sorbent capacity of 1.7 eq./L and a band concentration of 0.105 N. The column effluent was also monitored using an on-line photo diode array (PDA) detector for Nd and Pr. Fractions in the effluent were collected for analysis of La and Ce, using inductively coupled plasma optical emission spectroscopy (ICP-OES). The detailed experimental conditions were summarized in Table 5.

The design of the bastnasite simulant separation should be guided by the value of selectivity weighted composition factor _{Yi}. The _{Yi} values of each component are listed in the table below. Notice that Gd was not considered in the design because of its trace amount.

Table 4

_{Yi} Values for all Components in the Bastnasite Simulant

| Component | Molar fraction (xᵢ) | ${α}_{i - 1 , i}^{e}$ | ${α}_{i , i + 1}^{e}$ | ${γ}_{i} = \frac{{x}_{i}}{\frac{{α}_{i - 1 , i}^{e} + 1}{{α}_{i - 1. i}^{e} - 1} + \frac{{α}_{i . i + 1}^{e} + 1}{{α}_{i , i + 1}^{e} - 1}}$ |
|---|---|---|---|---|
| Sm | 0.012 | »1 | 3.2 | 0.004 |
| Nd | 0.143 | 3.2 | 1.8 | 0.026 |
| Pr | 0.048 | 1.8 | 2.5 | 0.008 |
| Ce | 0.500 | 2.5 | 3.7 | 0.123 |
| La | 0.286 | 3.7 | »1 | 0.104 |

Table 5

Experimental Conditions and Simulation Parameters for the Separation of a Bastnäsite Concentrate Simulant Mixture (unit: mN)
System parameters

| L (cm) | ID (cm) | R (µm) | εb | εp | Flow rate (ml/min) | Feed volume (ml) | Component | Concentration(mN) |
|---|---|---|---|---|---|---|---|---|
| 34.5 | 1.16 | 63 | 0.36 | 0.28 | 2.04 | 37.7 | Gd | 0.16 |
| | | | | | | | Sm | 10 |
| | | | | | | | Nd | 120 |
| | | | | | | | Pr | 40 |
| | | | | | | | Ce | 420 |
| | | | | | | | La | 250 |

Isotherm Parameters (Modulated Langmuir isotherm)

| | | | | | | |
|---|---|---|---|---|---|---|
| Component | | a | b | Sa | Sb | Effective selectivity α_{i,i-1} |
| 1 | Modulator | 1700 | 1 | 0 | 0 | |
| 2 | Cu | 8500 | 5 | 0 | 0 | |
| 3 | Sm | 8500 | 5 | 0 | 0 | 5 |
| 4 | Nd | 8500 | 5 | -1.16315 | -1.16315 | 3.2 |
| 5 | Pr | 8500 | 5 | -1.75094 | -1.75094 | 1.8 |
| 6 | Ce | 8500 | 5 | -2.66723 | -2.66723 | 2.5 |
| 7 | La | 8500 | 5 | -3.97556 | -3.97556 | 3.7 |
| 8 | EDTA | 8500 | 5 | -5.58499 | -5.58499 | 5 |

Mass Transfer Parameters

| | | | | |
|---|---|---|---|---|
| Component | Brownian diffusivity, D_{b} (cm²/min) | Pore diffusivity, Dₚ (cm²/min) | Axial dispersion coefficient, E_{b} (cm²/min) | Film mass transfer coefficient, k_{f} (cm/min) |
| All species | 4x 10⁻⁴ | 9x10⁻⁵ | Chung and Wen (1968) | Wilson and Geankoplis (1966) |

Numerical Parameters (unit: N)

| | | | | | |
|---|---|---|---|---|---|
| Axial element | Step size (L/u₀) | Collocation points | | Tolerance | |
| | | Axial | Particle | Absolute | Relative |
| 151 | 0.01 | 4 | 2 | 10⁻³ | 10^{–3} |

Among all the components in the simulant, Ce has the largest γᵢ value, which means that separating Ce from the rest would be the easiest task in a single column. To maximize the productivity, one should choose Ce as the first target component.

As explained above, a target yield of 80% for Ce was expected to give the highest sorbent productivity. The loading volume was 10% lower than that in the design to ensure that the mass transfer zones reached constant pattern. The minor REE components (Gd, Sm, Nd, and Pr) were expected to elute together as a group and can be further separated using additional columns.

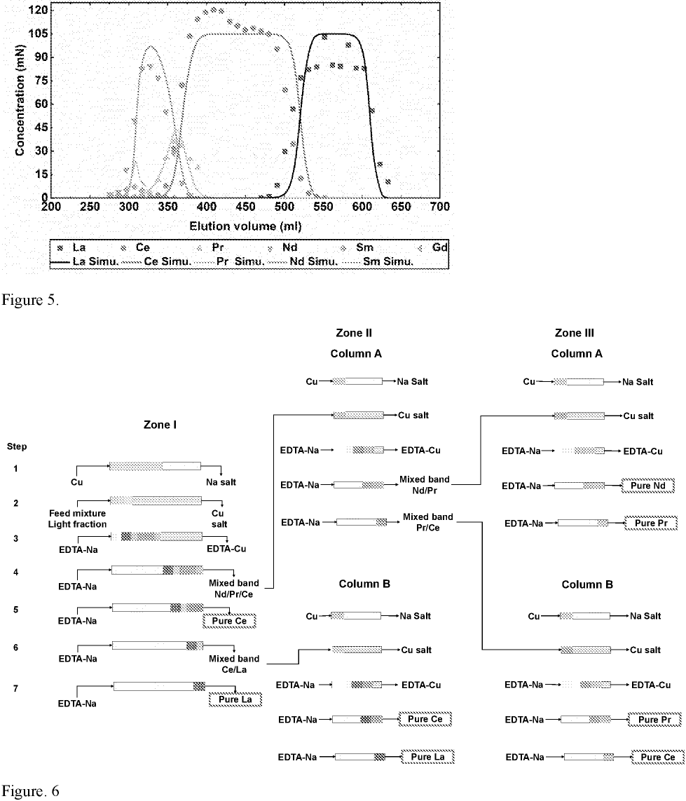

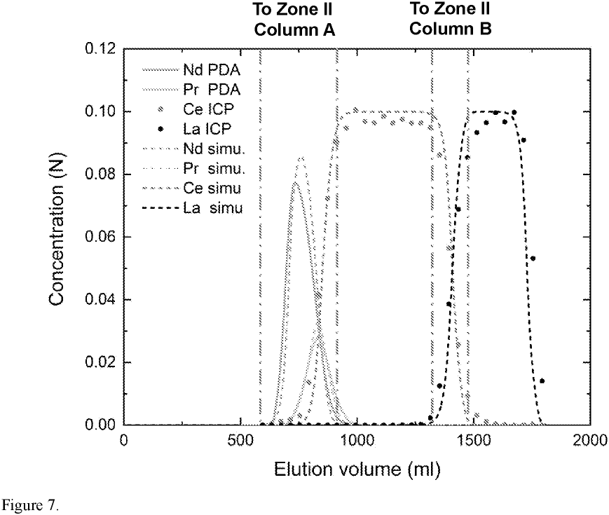

The results of the LAD separation of the simulant are shown in FIG. 5. The experimental and simulated chromatograms (VERSE) are in close agreement. Gd was eluted ahead of all other REEs (not shown in FIG. 5). For an actual REE mixture from bastnasite concentrate, other trace elements (Eu, Er, Dy, Ho, Tb, Y, Sc) having a similar or higher ligand affinity than Gd are expected to elute ahead of or with Gd. As intended in this design, Sm, Nd, and Pr were not separated and eluted as a group.

Table 6

Yields and Productivity in the Separation of Bastnasite Simulant

| Component | Target yield (%) | Experimental yield (%) | Productivity (kg/m³/day) |
|---|---|---|---|
| Ce | 80 | 77 | 85 |
| La | | 83 | 54 |

The design target yields of Ce and La agreed closely with the experimental yields within 3% experimental error (Table 6). The results indicate that the constant pattern design method was effective in splitting this mixture with 7 REEs.

The La in the mixed band between La and EDTA-Na was considered as pure La since the Na and La can be easily separated by precipitation of La. The overall productivity for producing the high purity of Ce and La for this design was 85 + 54 = 139 kg/m³/day. The yields of La and Ce can be further increased by recycling the mixed bands as explained in the next section below.

The minority REEs, Nd and Pr, and the trace REEs, Sm and Gd, were not separated in this column by design. This result was intended in applying the Constant-Pattern Design method. The flow rate was chosen to maximize the productivity for producing high-purity La and Ce, the two major components. One can apply the design method to separate and recover all six REEs with high-purity and high yield in a single column. However, a very low velocity is needed to reduce the overlapping regions (mixed bands), resulting in a long cycle time and low sorbent productivity. The separation will be bottled-necked by the minority REEs, or even more by the trace REEs. For example, using the same column that was used to separate bastnasite simulant in our test, if 80% yield of Pr instead of Ce was targeted in the design with 5% breakthrough cut, the productivity of Ce and La will drop dramatically to 1.4 and 0.8 kg/m³/day, respectively, which are one sixtieth of the productivities if Ce is the target component. Similar to the case of REE crude derived from waste magnets, when there is a minor component present in the feed, a “divide-and-conquer” strategy is most efficient for the recovery of high purity REEs. One can increase productivity by at least an order of magnitude by dividing the purification tasks using multiple zones, as explained in the example in the next section.

### Separation of REEs From the Light REE Crude From Mountain Pass

The Mountain Pass ore contains about 8-12% REO. After physical separation and ore beneficiation, the bastnasite concentrate had about 60% REO. After a series of chemical processing and preliminary separation, impurities including thorium and uranium were removed, and two REEcarbonate fractions were obtained: the light REE fraction (LREE) and the heavy fraction (HREE). The light fraction, which accounted for about 99% of the total REO content, had four carbonate salts: La, Ce, Pr, and Nd catbonates.

The LREEcrude from MP Materials was first dissolved in acid (1M HCI) to obtain a solution of REE chloride salts. The composition of the REEs in the solution was determined using ICP-OES, and it was used in the development of a three-zone LAD for the separation of the four components of the light fraction. (FIG. 6) The γᵢ values among the four components. Hence it is the easiest to separate and purify Ce first. La has a similar γᵢ value and elutes as the last band in LREE. Targeting high purity and high yield of Ce in the design would also achieve similar yield and purity for La.

Table 7

γᵢ Values for all Components in the Bastnasite Simulant

| Component | Concentration(N) | Molar fraction (xᵢ) | ${α}_{i - 1 , i}^{e}$ | ${α}_{i , i + 1}^{e}$ | ${γ}_{i} = \frac{{x}_{i}}{\frac{{α}_{i - 1 , i}^{e} + 1}{{α}_{i - 1 , i}^{e} - 1} + \frac{{α}_{i , i + 1}^{e} + 1}{{α}_{i , i + 1}^{e} - 1}}$ |
|---|---|---|---|---|---|
| Nd | 0.046 | 0.107 | »1 | 1.8 | 0.024 |
| Pr | 0.015 | 0.035 | 1.8 | 2.5 | 0.006 |
| Ce | 0.234 | 0.544 | 2.5 | 3.7 | 0.134 |
| La | 0.135 | 0.314 | 3.7 | »1 | 0.115 |

Similar to the design for the separation of the bastnasite simulant, the first zone was designed to guarantee a high productivity of the major component Ce. Since LA elutes after Ce and before EDTA, the design to produce Ce with high yield will also produce La with a similar yield. Nd and Pr will not be separated and will elute ahead of the Ce and La bands. The mixed band of Nd, Pr and Ce will be collected and sent to the second zone, Column II-A for further separation. A second mixed band of Ce and La from Zone I can be sent to Zone II, Column II-B to further increase the yields of La and Ce to >99%. Zone II-A aims to split the ternary mixture into two fractions, a fraction of Nd and Pr and a fraction of Pr and Ce. The two fractions from Zone II are sent to Zone III for further separation. The strategy is to reduce each mixed fraction eventually to binary mixtures. Finally, Pr can be produced with high purity in Zone III by collecting and separating the mixed bands from Zone II. In the binary separation columns, Zone IIB, Zone IIIA and Zone IIIB, the mixed bands can be recycled to its feed to achieve >99% yield of each component. In general, for a four-component feed mixture, three zones are needed to reduce the mixture to three binary mixtures.

### Experimental Testing of Zone I

In the design of the first zone, the Ce concentration in the feed was not measured accurately because of interference in the ICP-OES analysis. The Ce concentration from ICP-OES analysis was 40% lower than the actual concentration. As a result, the actual loading fraction was 40% higher than the designed loading fraction. the displacement train did not quite reach the constant-[attern state, resulting a lower yield (70%) than the design yarget yield (77%). In our future work, we plan to modify the constant-pattern design method to take into account of any uncertainies if feed composition, ligand concentration and pH, and flow rate. the designed loading fraction can be decreased, and the designed mobile phase velocity can be reduced so that the constant-pattern displacement train will be developed in the production system in spite of the uncertainties.

The simulation parameters for Zone I are listed in Table 8. The ligand used in Zone I was 0.03 M EDTA at pH=10.5, resulting in an effective capacity of 1.8 eq./L and an elution band concentration of 0.1 N. With given experimental conditions (flow rate, feed volume) the VERSE simulated yield if Ce should be 71.9%. The experimental yield of Ce with a purity of 99% was 70.3%, which is within the experimental error compared to the simulated yield.

Table 8

Experimental Conditions and Simulation Parameters for the Separation of the Light Fraction (unit: N)
System Parameters

| L (cm) | ID (cm) | R (µm) | ε_{b} | εₚ | Flow rate (ml/min) | Feed volume (ml) | Component | Concentration(N) |
|---|---|---|---|---|---|---|---|---|
| 89 | 1.16 | 63 | 0.36 | 0.28 | 6.66 | 237 | Nd | 0.046 |
| | | | | | | | Pr | 0.015 |
| | | | | | | | Ce | 0.234 |
| | | | | | | | La | 0.135 |

Isotherm Parameters (Modulated Langmuir Isotherm)

| | | | | | | | | | | | |
|---|---|---|---|---|---|---|---|---|---|---|---|
| Component | | | a | | b | | Sa | | Sb | | αᵢ-1,i |
| 1 | Modulator | | 1800 | | 1000 | | 0 | | 0 | | |
| 2 | Cu | | 9000 | | 5000 | | 0 | | 0 | | |
| 3 | Nd | | 9000 | | 5000 | | 0 | | 0 | | 5.0 |
| 4 | Pr | | 9000 | | 5000 | | -0.58779 | | -0.58779 | | 1.8 |
| 5 | Ce | 9000 | | 5000 | | -1.50408 | | -1.50408 | | 2.5 | |
| 6 | La | 9000 | | 5000 | | -2.81241 | | -2.81241 | | 3.7 | |
| 7 | EDTA | 9000 | | 5000 | | -4.42185 | | -4.42185 | | 5.0 | |

Mass Transfer Parameters

| | | | | |
|---|---|---|---|---|
| Component | Brownian diffusivity, D_{b} (cm²/min) | Pore diffusivity, Dₚ (cm²/min) | Axial dispersion coefficient, E_{b} (cm²/min) | Film mass transfer coefficient, k_{f} (cm/min) |
| All species | 4x 10⁻⁴ | 9ₓ10⁻⁵ | Chung and Wen (1968) | Wilson and Geankoplis (1966) |

Numerical parameters (unit: N)

| | | | | | |
|---|---|---|---|---|---|
| Axial element | Step size (L/u₀) | Collocation points | | Tolerance | |
| | | Axial | Particle | Absolute | Relative |
| 151 | 0.01 | 4 | 2 | 10⁻³ | 10^{–3} |

### Experimental Testing of Zone II

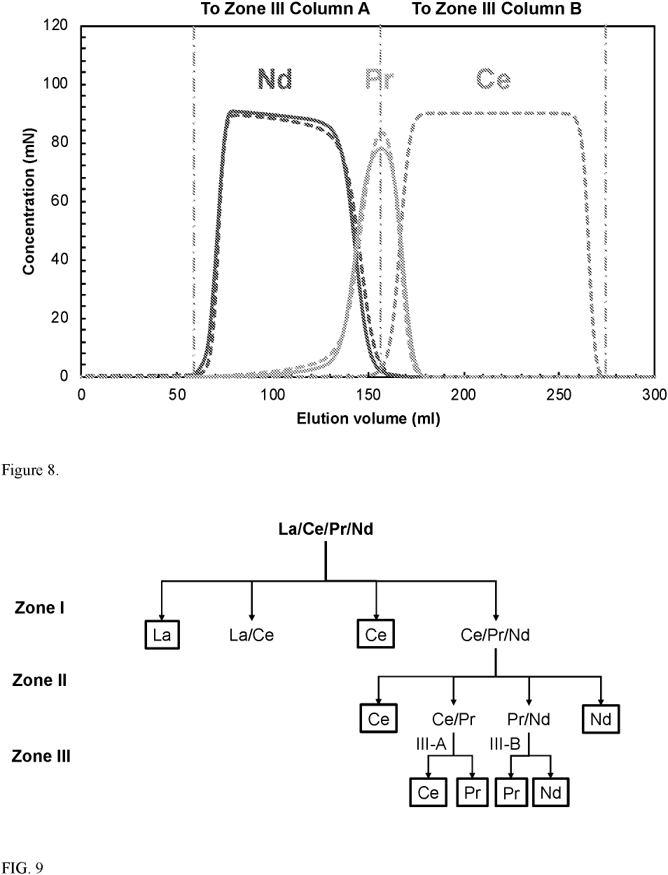

The mixed band of a ternary mixture of Nd, PR and Ce was collected. The cikyne if the mixed band in this test was about 390 ml, 300 ml of which was directly fed into Zone IIA for further separation. the feed solution to Zone IIA was a mixture if EDTA-REE complexes. There was a complication as a result of direct recycle of te EDTA-REE mixture from Zone I as the feed to Zone II-A. In Zone I, all the REEs were in the salt form and they would adsorb on the adsorbent as a uniform band with a shart boundary. By contrast, the EDTA-REE mixtures started to separate and spread during the loading period bexuase of the presence of EDTA in the feed. As a result, the experimental elution profiles showed fronting of the Pr band (FIG. 8). Simulations were used to confirm this explanation. The constant separation factor isotherm was used to simulate the separation in Zone IIA. The feed composition and other experimental parameters for Zone IIA. The feed composition and other experimental parameters for Zone IIA are listed in Table 9.

A fast flow rate (10 ml/min) was used in the loading to reduce the loading time. However, because the separation and spreading during loading, this flow rate was too dast for the waves to sharpen to reach the constant-pattern state, resulting in an apparent leakage of Pr into the Nd band, which lowered the yield of high purity Nd (FIG. 8).

One way to overcome this problem is to add acid to precipitate EDTA in the EDTA-REE soulution before loading the mixed band to Zone II. If the EDTA is removed from the feed mixture, the high flow rate during loading in Zone II will not affect the separation. The sorbent has a high affinity and negligible selectivity for all the REEs, the loading zone will have a uniform REE band with a sharp boundary. The yield of each component will not be affected by the loading velocity, but it will only dependon the flow rate, or the linear velocity, of the ligand solution during elution.

Table 9

Experimental Conditions and Simulation Parameters for Zone IIfor the Separation of Light Fraction (unit mN)
System Parameters

| L (cm) | ID (cm) | R (µm) | ε_{b} | εₚ | Flow rate (ml/min) | Feed volume (ml) | Component | Concentration(mN) |
|---|---|---|---|---|---|---|---|---|
| 15 | 1.16 | 63 | 0.4 | 0.28 | 10 in loading 0.7 in elution | 300 | EDTA-Nd | 22 |
| | | | | | | | EDTA-Pr | 7 |
| | | | | | | | EDTA-Ce | 29.5 |

Isotherm Parameters (Modulated Langmuir Isotherm)

| Effective Capacity (meq./L) | | 1,500 |
|---|---|---|
| Component | | Separation factor |
| 1 | Cu | 1 |
| 2 | Nd | 5 |
| 3 | Pr | 9 |
| 4 | Ce | 22.5 |
| 5 | EDTA-Na | 112.5 |

Mass Transfer Parameters

| | | | | |
|---|---|---|---|---|
| Component | Brownian diffusivity, D_{b} (cm²/min) | Pore diffusivity, Dₚ (cm²/min) | Axial dispersion coefficient, E_{b} (cm²/min) | Film mass transfer coefficient, k_{f} (cm/min) |
| All species | 4x 10⁻⁴ | 9x10⁻⁵ | Chung and Wen (1968) | Wilson and Geankoplis (1966) |

Numerical Parameters (unit: N)

| | | | | | |
|---|---|---|---|---|---|
| Axial element | Step size (L/u₀ | Collocation points | | Tolerance | |
| | | Axial | Particle | Absolute | Relative |
| 151 | 0.01 | 4 | 2 | 10⁻³ | 10⁻³ |

The mixed band of Nd, PR, and Ce can be split into two binary fractions, the Nd/Pr fraction and the Pr/Ce fraction and the Pr/Ce Fraction, which will be separated in Zone III-A and Zone III-B, respectively, where high-purity Pr can be obtained.

The overall yields and productivity in the two zones are summarized in Table 10 below.

Table 10

Yield and Productivity in Experimental Tests on Separation of Light Fraction from Mountain Pass REEs Mine

| Zone | Elements | Yield (%) | Purity (%) | Productivity (kg/m³/day) |
|---|---|---|---|---|
| Zone I | Ce | 70.3 | 99.86 | 103.1 |
| | La | 75.8 | 99.78 | 63.6 |
| Zone II-A | Nd | 44.8 | 99.00 | 31.7 |
| | Ce | 92.5 | 99.90 | 21.6 |
| Overall average two-zone REE Productivity (kg/m³/day) | | | | 43.6 |

The yield of high purity Nd will be improved in Zone II if the mixed band is properly treated before feeding into the column. An improved and detailed three-zone design is developed and explained in the next section.

### Theoretical Design for Reaching >99% Yields for All Four REEs

As shown in Table 7, Ce has the highest γᵢ value in the given feed; hence, it is the easiest component to separate first. Therefore, Ce is the target component in Zone I, Where the majority of Ce and La will be obtained as pure products, and all of Nd and Pr as well as a small fraction of Ce will be collected in the mixed band and sent ti Zone II-A. The Ce/La mixed band can be sent to Zone II-B for further separation.

The composition in the mixed band of Nd, Pr, Ce is calculated for evaluating the γᵢ values for all three components before designing Zone II. As shown in Table 11, Nd has the largest γᵢ value, and PR has the smallest γᵢ value, hence it will be the most difficult component to obtain high yield of high purity product. The goal of Zone IIis to split Nd from Pr and Ce. The target yield of Nd would be 74% so that Ce band will not spread to Nd band and the ternary mixture would be split into two clean binary pairs for further separation.

The mixed band of Ce/La from Zone I will be separated into pure fractions in Zone II Column B. A 73.4% yield of Ce was targeted to achieve highest yield. the Ce/La mixed band from Zone I will be a binary mixture since the mass transfer zone are symmetric. The mixed band can be then recycled back into the feed if this column without causing any change in feed composition or design parameters, but the overall yield would be increased to >99%.

Two columns (IIIA and IIIB)will be placed in Zone III to separate the Nd/Pr and Pr/Ce mixed bands generated from Zone II Column A. The yields of the target components were chosen to maximize sorbent productivities. The mixed bands will be recycled into the respective feeds so that the overall yields of all three components would be >99%.

The detailed design parameters are listed below in Table 11. The band concentration in the design was increased to 0.2 N by using 0.06 M EDTA, instead of 0.03 M EDTA in the experiments, to increase the productivity. Recent test results showed that the ligand concentration can be increased further to 0.075 M at pH 10 to increase the productivity in Table 11 by an additional 25%. Experimental results are in progress.

Table 11

Theoretical Multi-Zone Design for Achieving >99% Yields for all Component (0.06 M EDTA, at pH 10.5)

| | L_{c} (cm) | I.D (cm) | V_{c} (ml) | v_{f} (ml) | Q (ml/min) | c_{f,i} (N) | | γᵢ | Yᵢ (%) | PRᵢ (kg/m³/day) | tₑ (min) |
|---|---|---|---|---|---|---|---|---|---|---|---|
| Zone I | 100 | 5 | 1963.5 | 4,525.00 | 119.0 | Nd | 0.046 | 0.024 | 0 | 0 | 160 |
| | | | | | | Pr | 0.015 | 0.006 | 0 | 0 | |
| | | | | | | Ce | 0.234 | 0.134 | 78.6 | 188.5 | |
| | | | | | | La | 0.135 | 0.115 | 84.3 | 96.6 | |
| Zone II Column A | 100 | 2.8 | 615.8 | 2,975.00 | 29.0 | Nd | 0.087 | 0.119 | 74.3 | 119.0 | 200 |
| | | | | | | Pr | 0.028 | 0.030 | 0 | 0 | |
| | | | | | | Ce | 0.047 | 0.087 | 83.8 | 66.8 | |
| Zone II Column B | 100 | 1.2 | 201.6 | 600 | 11 | Ce | 0.100 | 0.184 | 73.3 | 295.3 | 100 |
| | | | | | | La | 0.100 | 0.181 | 85.8 | 342.7 | |
| Zone III Column A | 100 | 1.8 | 254.5 | 784 | 8.0 | Nd | 0.100 | 0.111 | 75.7 | 57.9 | 300 |
| | | | | | | Pr | 0.100 | | 83.1 | 62.1 | |
| Zone III Column B | 100 | 0.9 | 63.6 | 261 | 3.9 | Pr | 0.100 | 0.214 | 74.0 | 153.6 | 150 |
| | | | | | | Ce | 0.100 | | 85.1 | 175.7 | |
| Total column volume (ml) | | | 3,099 | | | | Overall productivity (kg/m³/day) | | | 262.6 | |

The overall average productivity would be 262.6 kg/m³/day. However, if only one column is used, the 1 m column with 63 micros particle size cannot even reach 99% yield for Nd and Pr due to mass transfer limitations. To reach about 92% yields for Pr, the overall productivity would be only 0.035 kg/m³/day, which is about 7,700 times lower than that in the three-zone design.

### Scale-up Design for a Pilot Scale Plant for Processing 1-Ton LREE Crude/Day

The three-zone design tested at laboratory scale was used as the basis for scaling up to process 1 ton of REEs per day. The scale up factor was 1,230. The column lengths in Table 11 were kept the same but the diameters were increased. A total column volume of 3.81 m³ was required to process 1 ton/day of REEs with an overall productivity of 262.6 kg/m³/day.

Table 12

Column Dimensions in the Scale-Up Design for Processing 1 ton of LREE Per Day

| | Column length (m) | Column diameter (m) | Flow rate (L/min) | Column volume (m³) |
|---|---|---|---|---|
| Zone I | 1 | 1.75 | 146.4 | 2.41 |
| Zone II Column A | 1 | 1.00 | 35.7 | 0.76 |
| Zone II Column B | 1 | 0.42 | 13.5 | 0.25 |
| Zone III Column A | 1 | 0.63 | 9.8 | 0.31 |
| Zone III Column B | 1 | 0.32 | 4.8 | 0.08 |
| Total | | 5 columns | | 3.81 |

### Comparison Between a LAD System and Conventional Liquid-Liquid Extraction

In a typical liquid-liquid extraction plant for REEs purification, multiple extraction stages are required. For example, to separate Nd from the light REEs fraction using organophosphorus extractant P204, 80 stages are used for extraction, scrubbing, and stripping. The volume ratio between organic phase and aqueous phase is 9 to 1. High concentration acid (3 M HCl) is used for stripping and scrubbing.

A detailed comparison between LAD and liquid-liquid extraction is summarized in the table below.

Table 13

Comparison Between LAD and Liquid-Liquid Extraction

| 1 ton/day REEs purified | LAD | Liquid-liquid extraction ¹¹ |
|---|---|---|
| Typical yields (%) | >99% | 80-95% |
| Chemical | Water, dilute acid, dilute base, EDTA, Cu²⁺ solution | Organic solvents (up to 10 times feed volume), High concentration acid and ammonia Toxic extractants |
| Acid Consumed (tons/ton REO) | 0.8 | 9 |
| Acid Concentration (M) | 1 | 3-6 |
| Wastewater | No wastewater, >95% chemical reused | Discharge 50 tons acidic (pH=0.9) wastewater with 2.6 tons salt |
| Number of Units | 1 unit (5 columns) | 2,000 mixer-and-settler units |
| Normalized productivity | 100 | 1 |
| Normalized processing Volume | 1 | 100 |

The analytical methods using photodiode array detector and inductively coupled plasma optical emission spectroscopy were developed for the analysis of REEs in the aqueous solutions. These two methods can effectively determine the concentrations in the feed solution, which are essential parameters for the constant-pattern design.

A mixture of 7 visible REEs were first separated using a single column. The design method as well as the rate model simulations were verified. Experimental results for most of the components agree closely to the simulation results.

Then a simulant with similar REEs concentrations to bastnasite was prepared and separated. High purity La and Ce were recovered with yields closely matched with the targeted yields in the design method. The heavy REEs will have higher ligand affinity and elute ahead of the light REEs. In this test, minor component eluted as a group without separation.

A crude LREE mixture provided by MP Materials was separated using a multi-zone LAD system. The constant pattern design method was modified and improved by incorporating the splitting method based on the y values for splitting complex mixtures. A multi-zone design based on the constant-pattern method was developed for the light REEs fraction. The component with largest _{Yi} value (Ce) was targeted and separated in Zone I. Column A in Zone II split the ternary mixed band (Nd/Pr/Ce) into two binary pairs (Nd/Pr, Pr/Ce). These two binary pairs were separated using a third zone to obtain high purity Nd, Pr and Ce with high productivity. Column B in Zone II separated Ce/La mixed band to improve yields of these two elements. In general, for a four-component REEs mixture, 3 zones were required to eventually separate the multi-component mixture into binary pairs. For the separation of a binary mixture, the mixed band in the effluent can be recycled back to the column inlet as part of the feed. The mixed band would be approximately an equimolar mixture because the concentration profiles in the mass transfer zone are symmetric. By using a three-zone design for LREEs fraction, the overall productivity improved by three orders of magnitude compared to that in a single column.

Comparing to the conventional liquid-liquid extraction, the LAD will have about 100 times higher productivity, leading to only one hundredth of the processing volume. Only one LAD system with five columns is required to produce 1 ton/day, while the extraction method would require about 2,000 mixer-and-settler units. Instead of using a large amount of organic solvents, highly concentrated acids and ammonium salts, and highly toxic extractant, only benign EDTA solution is used in LAD. No acidic wastewater is discharged. More than 95% of the chemicals can be recovered and reused, generating little waste.

### LBD Separation Examples

### Example 1: LBD Separation of La, Ce, Pr, and Nd (4 Target Products) from Bastnasite Light Fraction Using 3 Zones and 4 Columns. (General Splitting Strategy 1)

The feedstock is the same set forth in Table 7 above. Each of the four REEs is recovered as an individual, high-purity product. A ligand (e.g. EDTA) bound sorbent is used to separate four high-purity REEs from the bastnasite light fraction. A weakly adsorbing component (for the immobilized EDTA), Na⁺, is used as the presaturant, and a strongly adsorbing component H⁺is used as the displacer. The high ligand-affinity REE, Nd, elutes last, while low ligand-affinity REE, La, elutes first.

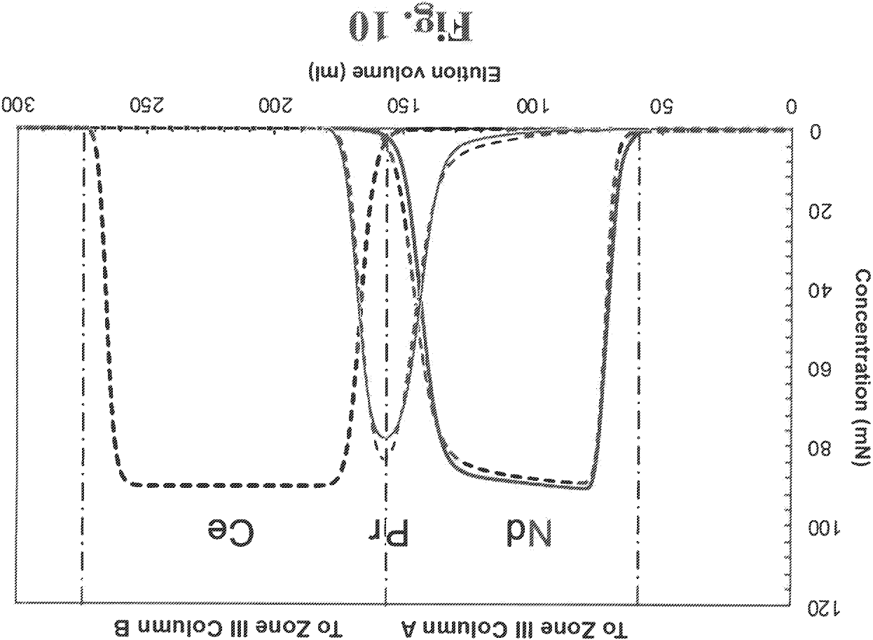

A three-zone design (FIG. 9) is developed following the general splitting strategy 1. The design of Zone I aims to maximize the productivity of Ce since it has the highest _{Yi} value among the four REEs. The yield of La also reached 80% in Zone I, which indicates that the collected La band from this Zone can also qualify as a high-purity (>99.5%) product. The mixed band between La and Ce can be recycled to the column inlet to improve the overall yields of both components.

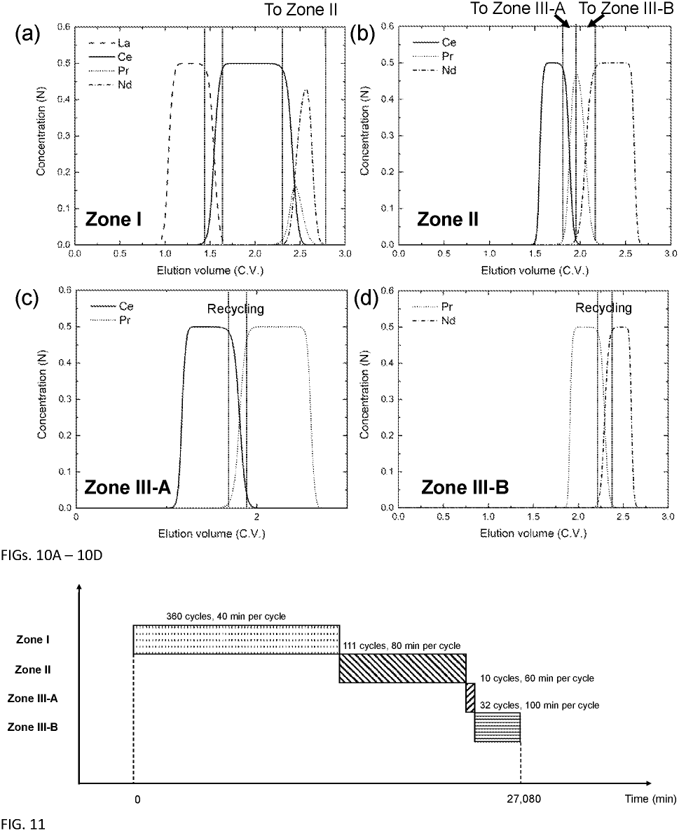

Neither Pr nor Nd reaches the plateau concentration in Zone I, FIG. 10A; therefore, Pr and Nd will be collected with Ce in a ternary mixed band, Ce/Pr/Nd, which is sent to Zone II for further purification. In the Ce/Pr/Nd ternary mixture, Nd has the highest _{Yi} value and should be the target product in Zone II. Under the conditions where Nd productivity is maximized in Zone II, Ce can also be drawn out as a high-purity product, FIG. 2(b). The middle component, Pr, reaches the plateau concentration, indicating almost complete separation between the Ce and Nd bands in Zone II (FIG. 10B). Therefore, one can split the ternary mixed band from Zone II into two binary mixed bands, Ce/Pr and Pr/Nd, which are further separated in Zone III Columns A and B, respectively. Components in the binary mixtures that fed into the two columns in Zone III are recovered as pure products. Each column generates one binary mixed band, which is recycled to the respective column inlet to increase the overall yield to >99%. The simulated elution profiles for all the zones are shown in FIGS. 10A-10D and 11.

Table 14

Yields and Productivities for Producing all Four Components from Light Fraction Using a Single Column Design

| Component | Single Column Design | | Three-Zone Design | |
|---|---|---|---|---|
| | Yield (%) | Productivity (kg/m³ sorbent/day) | Yield (%) | Productivity (kg/m³ sorbent/day) |
| La | 99.8 | 0.232 | >99 | 213.5 |
| Ce | 99.7 | 0.406 | >99 | 370.0 |
| Pr | 94.2 | 0.025 | >99 | 23.8 |
| Nd | 98.9 | 0.082 | >99 | 72.8 |
| Overall | 99.48 | 0.745 | >99 | 680.2 |

Table 15

Simulation Parameters for Example 4 Zone I

| L (cm) | | ID (cm) | | | R (µm) | | | ε_{b} | ε_{P} | Feed volume (ml) | | | Flow rate (ml/min) | Feed concentration (N) | | | |
|---|---|---|---|---|---|---|---|---|---|---|---|---|---|---|---|---|---|
| 100 | | 10 | | | 56 | | | 0.40 | 0.3 | 5,970 | | | 853 | La | | 0.314 | |
| | | | | | | | | | | | | | | Ce | | 0.544 | |
| | | | | | | | | | | | | | | Pr | | 0.035 | |
| | | | | | | | | | | | | | | Nd | | 0.107 | |
| Isotherm Parameters (Constant Separation Factor Isotherm) | | | | | | | | | | | | | | | | | |
| qₘₐₓ = 1 meq./mL | | | | | | | | | | | | | | | | | |
| Component | | | | Separation Factor | | | | | | | | | | | | | |
| 1 | Presaturant | | | 1 | | | | | | | | | | | | | |
| 2 | La | | | 5 | | | | | | | | | | | | | |
| 3 | Ce | | | 18.5 | | | | | | | | | | | | | |
| 4 | Pr | | | 46.25 | | | | | | | | | | | | | |
| 5 | Nd | | | 83.25 | | | | | | | | | | | | | |
| 6 | Displacer | | | 416.25 | | | | | | | | | | | | | |
| Mass transfer parameters | | | | | | | | | | | | | | | | | |
| Component | | | Brownian diffusivity, D_{b} (cm²/min) | | | | Pore diffusivity, Dₚ (cm²/min) | | | | Axial dispersion coefficient, E_{b} (cm²/min) | | | | Film mass transfer coefficient, k_{f} (cm/min) | | |
| All species | | | 4×10⁻⁴ | | | | 1×10⁻⁴ | | | | Chung and Wen (1968) | | | | Wilson and Geankoplis (1966) | | |
| Numerical Parameters (Unit: N) | | | | | | | | | | | | | | | | | |
| Axial Element | | | Step Size (L/u₀) | | | Collocation Points | | | | | | Tolerance | | | | | |
| | | | | | | Axial | | | Particle | | | Absolute | | | | | Relative |
| 151 | | | 0.01 | | | 4 | | | 2 | | | 3×10⁻⁶ | | | | | 10⁻³ |

Table 16

Simulation Parameters for Example 4 Zone II

| L (cm) | | ID (cm) | | | R (µm) | | | ε_{b} | ε_{P} | Feed volume (ml) | | | Flow rate (ml/min) | Feed concentration (N) | | | |
|---|---|---|---|---|---|---|---|---|---|---|---|---|---|---|---|---|---|
| 100 | | 10 | | | 56 | | | 0.40 | 0.3 | 11,390 | | | 443 | Ce | | 0.110 | |
| | | | | | | | | | | | | | | Pr | | 0.061 | |
| | | | | | | | | | | | | | | Nd | | 0.188 | |
| Isotherm Parameters (Constant Separation Factor Isotherm) | | | | | | | | | | | | | | | | | |
| qₘₐₓ = 1 meq./mL | | | | | | | | | | | | | | | | | |
| Component | | | | Separation factor | | | | | | | | | | | | | |
| 1 | Presaturant | | | 1 | | | | | | | | | | | | | |
| 2 | Ce | | | 5 | | | | | | | | | | | | | |
| 3 | Pr | | | 12.5 | | | | | | | | | | | | | |
| 4 | Nd | | | 22.5 | | | | | | | | | | | | | |
| 5 | Displacer | | | 112.5 | | | | | | | | | | | | | |
| Mass Transfer Parameters | | | | | | | | | | | | | | | | | |
| Component | | | Brownian diffusivity, D_{b} (cm²/min) | | | | Pore diffusivity, Dₚ (cm²/min) | | | | Axial dispersion coefficient, E_{b} (cm²/min) | | | | Film mass transfer coefficient, k_{f} (cm/min) | | |
| All species | | | 4×10⁻⁴ | | | | 1×10⁻⁴ | | | | Chung and Wen (1968) | | | | Wilson and Geankoplis (1966) | | |
| Numerical Parameters (unit: N) | | | | | | | | | | | | | | | | | |
| Axial element | | | Step size (L/u₀) | | | Collocation Points | | | | | | Tolerance | | | | | |
| | | | | | | Axial | | | Particle | | | Absolute | | | | | Relative |
| 151 | | | 0.01 | | | 4 | | | 2 | | | 6×10⁻⁶ | | | | | 10⁻³ |

Table 17

Simulation Parameters for Example 4 Zone III-A

| L (cm) | | ID (cm) | | | R (µm) | | | ε_{b} | ε_{P} | Feed Volume (ml) | | | Flow Rate (ml/min) | Feed Concentration (N) | | | |
|---|---|---|---|---|---|---|---|---|---|---|---|---|---|---|---|---|---|
| 100 | | 10 | | | 56 | | | 0.40 | 0.3 | 11,320 | | | 686 | Ce | | 0.220 | |
| | | | | | | | | | | | | | | Pr | | 0.276 | |
| Isotherm Parameters (Constant Separation Factor Isotherm) | | | | | | | | | | | | | | | | | |
| qₘₐₓ = 1 meq./mL | | | | | | | | | | | | | | | | | |
| Component | | | | Separation Factor | | | | | | | | | | | | | |
| 1 | Presaturant | | | 1 | | | | | | | | | | | | | |
| 2 | Ce | | | 5 | | | | | | | | | | | | | |
| 3 | Pr | | | 12.5 | | | | | | | | | | | | | |
| 4 | Displacer | | | 62.5 | | | | | | | | | | | | | |
| Mass Transfer Parameters | | | | | | | | | | | | | | | | | |
| Component | | | Brownian diffusivity, D_{b} (cm²/min) | | | | Pore diffusivity, Dₚ (cm²/min) | | | | Axial dispersion coefficient, E_{b} (cm²/min) | | | | Film mass transfer coefficient, k_{f} (cm/min) | | |
| All species | | | 4x10⁻⁴ | | | | 1x10⁻⁴ | | | | Chung and Wen (1968) | | | | Wilson and Geankoplis (1966) | | |
| Numerical Parameters (unit: N) | | | | | | | | | | | | | | | | | |
| Axial element | | | Step size (L/u₀) | | | Collocation Points | | | | | | Tolerance | | | | | |
| | | | | | | Axial | | | Particle | | | Absolute | | | | | Relative |
| 151 | | | 0.01 | | | 4 | | | 2 | | | 2×10⁻⁵ | | | | | 10⁻³ |

Table 18

Simulation parameters for Example 4 Zone III-B

| L (cm) | | ID (cm) | | | R (µm) | | | ε_{b} | ε_{P} | Feed volume (ml) | | | Flow rate (ml/min) | Feed Concentration (N) | | | |
|---|---|---|---|---|---|---|---|---|---|---|---|---|---|---|---|---|---|
| 100 | | 10 | | | 56 | | | 0.40 | 0.3 | 5,380 | | | 295 | Pr | | 0.272 | |
| | | | | | | | | | | | | | | Nd | | 0.227 | |
| Isotherm Parameters (Constant Separation Factor Isotherm) | | | | | | | | | | | | | | | | | |
| qₘₐₓ = 1 meq./mL | | | | | | | | | | | | | | | | | |
| Component | | | | Separation factor | | | | | | | | | | | | | |
| 1 | Presaturant | | | 1 | | | | | | | | | | | | | |
| 2 | Ce | | | 5 | | | | | | | | | | | | | |
| 3 | Pr | | | 9 | | | | | | | | | | | | | |
| 4 | Displacer | | | 45 | | | | | | | | | | | | | |
| Mass Transfer Parameters | | | | | | | | | | | | | | | | | |
| Component | | | Brownian diffusivity, D_{b} (cm²/min) | | | | Pore Diffusivity, Dₚ (cm²/min) | | | | Axial Dispersion Coefficient, E_{b} (cm²/min) | | | | Film Mass Transfer Coefficient, k_{f} (cm/min) | | |
| All species | | | 4×10⁻⁴ | | | | 1×10⁻⁴ | | | | Chung and Wen (1968) | | | | Wilson and Geankoplis (1966) | | |
| Numerical Parameters (Unit: N) | | | | | | | | | | | | | | | | | |
| Axial element | | | Step size (L/u₀) | | | Collocation Points | | | | | | Tolerance | | | | | |
| | | | | | | Axial | | | Particle | | | Absolute | | | | | Relative |
| 151 | | | 0.01 | | | 4 | | | 2 | | | 2×10⁻⁵ | | | | | 10⁻³ |

### Example 2: LBD Separation of Nd/Pr from Bastnasite Light Fraction. (General Splitting Strategies 2 & 3)

The feedstock is the same as for Examples 3 and 4; however, the target product of this example is only the mixture of Pr and Nd (didymium) instead of all four REEs. The same sorbent and displacer are used as in Example 1.

Pr and Nd are grouped as one component, Pr/Nd, and La and Ce are grouped as the second component, La/Ce. The mixture of 4 REEs is treated as a binary mixture. The compositions and selectivity weighted composition factors are listed in Table 19. For calculating the _{γi} value of Pr/Nd, the two selectivities on the two sides for the adjacent bands are α_{prce} and α_{H/Nd}.

Table 19

Compositions and Selectivity Weighted Composition Factors of Grouped Components

| Component | Molar fraction (xᵢ) | Selectivity weighted composition factor γᵢ |
|---|---|---|
| Pr/Nd | 0.142 | 0.037 |
| La/Ce | 0.858 | 0.224 |

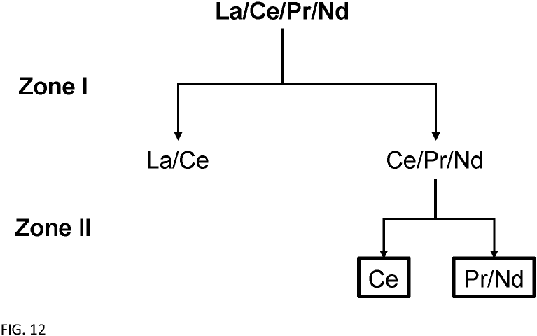

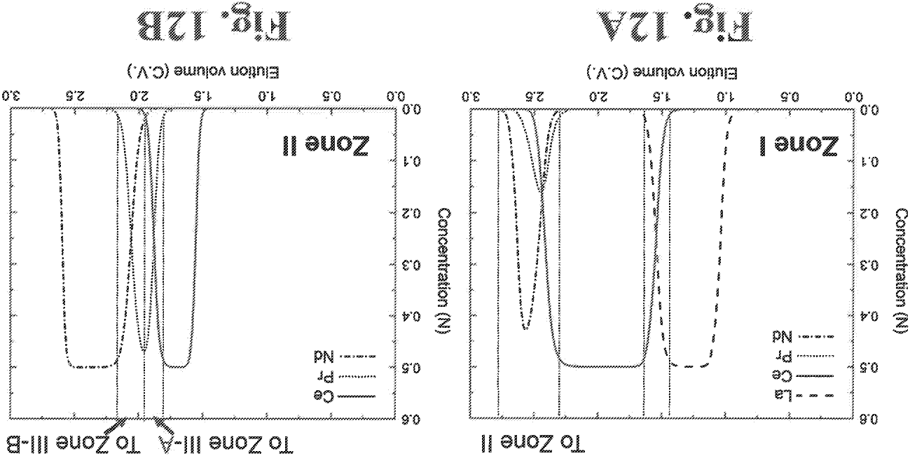

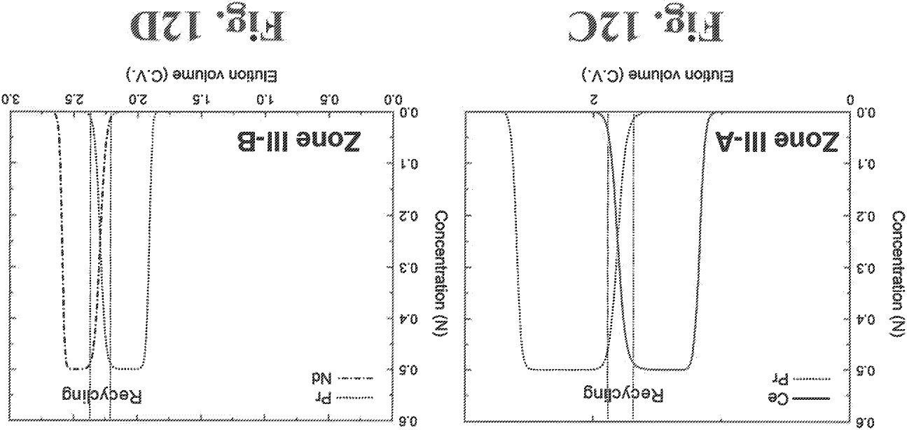

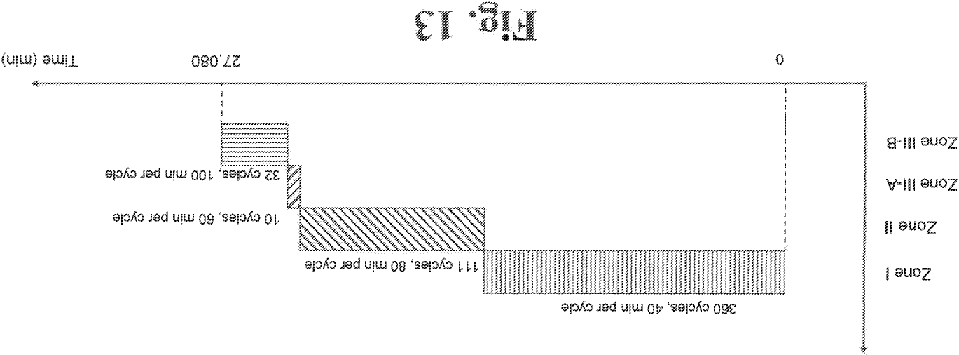

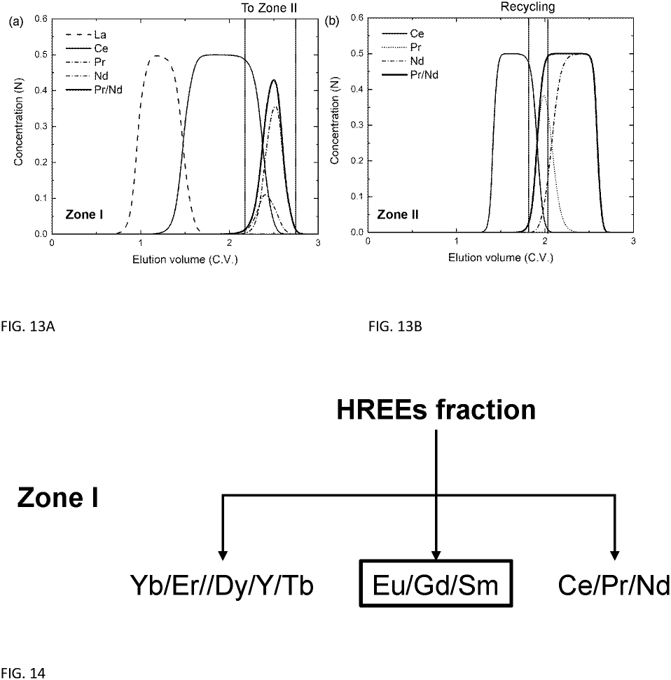

A two-zone design (FIG. 12) is developed for this example following the general splitting strategies 2 & 3. The grouped component, La/Ce, has a larger _{γi} value and will be the target product in the design of Zone I. When optimizing the productivity of La/Ce in Zone I, the yield of Pr/Nd is lower than 80%, which results in a purity lower than the target purity, 99.5%, as a result, Pr/Nd is collected with Ce and further purified in Zone II. Since Pr/Nd is grouped as one component, the mixed band generated from Zone I is treated as a binary mixed band (FIG. 13A). Pr/Nd has a larger _{γi} value in this binary mixed band hence is the target component of Zone II for maximizing productivity. Two products, Ce and Pr/Nd, will be recovered in Zone II as high purity products. The mixed band generated from this column can be recycled to the column inlet to increase the yield to >99%. The simulated elution profiles for the two columns are shown in FIGS. 13A-13B.

Table 20

Simulation Parameters for Example 2 Zone I

| L (cm) | ID (cm) | R (µm) | εb | εₚ | Feed volume (ml) | Flow rate (ml/min) | Feed concentration (N) | |
|---|---|---|---|---|---|---|---|---|
| 100 | 1 | 56 | 0.40 | 0.3 | 64.4 | 15.7 | La | 0.314 |
| | | | | | | | Ce | 0.544 |
| | | | | | | | Pr | 0.035 |
| | | | | | | | Nd | 0.107 |

Isotherm Parameters (Constant Separation Factor Isotherm)
qₘₐₓ = 1 meq./mL

| | | |
|---|---|---|
| Component | | Separation factor |
| 1 | Presaturant | 1 |
| 2 | La | 5 |
| 3 | Ce | 18.5 |
| 4 | Pr | 46.25 |
| 5 | Nd | 83.25 |
| 6 | Displacer | 416.25 |

Mass Transfer Parameters

| | | | | |
|---|---|---|---|---|
| Component | Brownian diffusivity, D_{b} (cm²/min) | Pore diffusivity, D_{b} (cm²/min) | Axial dispersion coefficient, diffusivity, E_{b} (cm²/min) | Film mass transfer coefficient, k_{f}(cm/min) |
| All species | 4x10⁻⁴ | 1x10⁻⁴ | Chung and Wen (1968) | Wilson and Geankoplis (1966) |

Numerical Parameters (Unit: N)

| | | | | | |
|---|---|---|---|---|---|
| Axial element | Step size (L/u₀) | Collocation points | | Tolerance | |
| | | Axial | Particle | Absolute | Relative |
| 151 | 0.01 | 4 | 2 | 3x10⁻⁶ | 10⁻³ |

Table 21

Simulation Parameters for Example 2 Zone II

| L (cm) | | ID (cm) | | | R (µm) | | | ε_{b} | εₚ | Feed volume (ml) | | | Flow rate (ml/min) | Feed concentration (N) | | | |
|---|---|---|---|---|---|---|---|---|---|---|---|---|---|---|---|---|---|
| 100 | | 1 | | | 56 | | | 0.40 | 0.3 | 130.8 | | | 7.56 | Ce | | 0.110 | |
| | | | | | | | | | | | | | | Pr | | 0.061 | |
| | | | | | | | | | | | | | | Nd | | 0.188 | |
| Isotherm Parameters (Constant Separation Factor Isotherm) | | | | | | | | | | | | | | | | | |
| qₘₐₓ = 1 meq./mL | | | | | | | | | | | | | | | | | |
| Component | | | | Separation factor | | | | | | | | | | | | | |
| 1 | Presaturant | | | 1 | | | | | | | | | | | | | |
| 2 | Ce | | | 5 | | | | | | | | | | | | | |
| 3 | Pr | | | 12.5 | | | | | | | | | | | | | |
| 4 | Nd | | | 22.5 | | | | | | | | | | | | | |
| 5 | Displacer | | | 112.5 | | | | | | | | | | | | | |
| Mass Transfer Parameters | | | | | | | | | | | | | | | | | |
| Component | | | Brownian diffusivity, D_{b} (cm2/min) | | | | Pore diffusivity, Dₚ (cm²/min) | | | | Axial dispersion coefficient, E_{b} (cm2/min) | | | | Film mass transfer coefficient, k_{f} (cm/min) | | |
| All species | | | 4×10⁻⁴ | | | | 1×10⁻⁴ | | | | Chung and Wen (1968) | | | | Wilson and Geankoplis (1966) | | |
| Numerical Parameters (unit: N) | | | | | | | | | | | | | | | | | |
| Axial element | | | Step size (L/u₀) | | | Collocation points | | | | | | Tolerance | | | | | |
| | | | | | | Axial | | | Particle | | | Absolute | | | | | Relative |
| 151 | | | 0.01 | | | 4 | | | 2 | | | 6×10⁻⁶ | | | | | 10⁻³ |

### Example 3 Recovery of Sm/Eu/Gd as a Group from Bastnasite Heavy Fraction Using LAD with a Single Column. (General Splitting Strategies 2 & 3)

This example demonstrates the recovery of one group of adj acent components, Sm/Eu/Gd, from a crude mixture of HREEs derived from bastnasite. The detailed composition and selectivity weighted composition factor are listed in Table 22.

Table 22

Mole Fractions and Selectivity Weighted Composition Factors in HREEs Derived from Bastnasite

| Element | Mole fraction (xᵢ) | Selectivity weighted composition factor (γi) |
|---|---|---|
| Yb/Er/Dy/Y/Tb | 0.158 | 0.0243 |
| Gd/Eu/Sm | 0.728 | 0.1054 |
| Nd/Pr/Ce | 0.114 | 0.0334 |

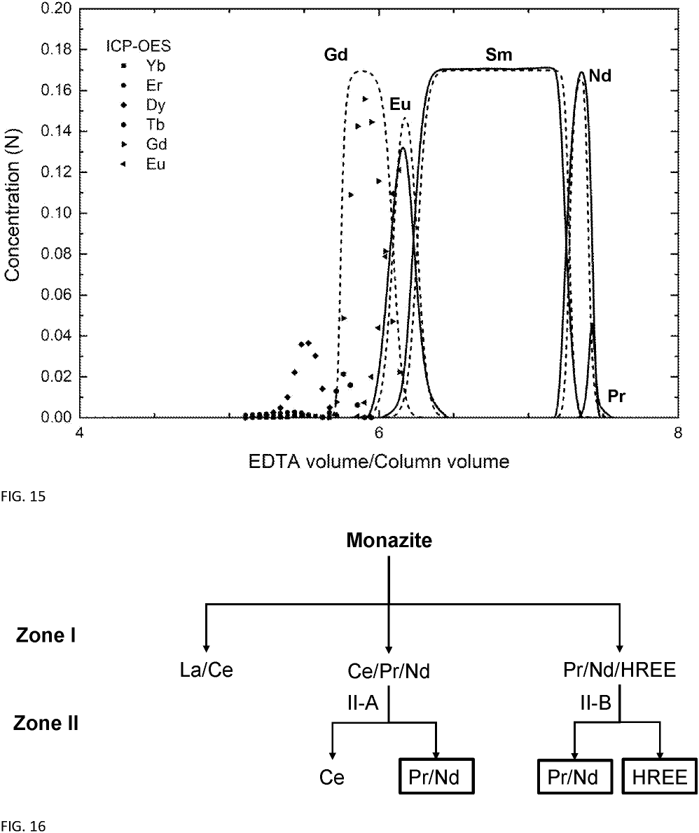

Based on the general splitting strategies 2 & 3, the complex HREEs mixture is divided into three groups, (Yb/Er/Dy/Y/Tb), (Gd/Eu/Sm), and (Nd/Pr/Ce). The feedstock is treated as a ternary mixture. The middle group, (Gd/Eu/Sm) has the highest _{Yi} value among the three groups, and will be the target group in Zone I. Only one zone is needed to recover this middle group. The experimental and simulated elution profile for Zone I are shown in FIG. 15. Two mixed bands (Gd/Tb) and (Sm/Nd) will be recycled to the column inlet to improve the overall yield of Sm/Eu/Gd to >99%. The other REEs will not be recycled to prevent accumulation of the impurities in the column, which will prevent the system from reaching a cyclic steady state.

### Example 4 LBD Separation of Two Groups, (Nd/Pr) and (HREEs), from a Monazite Concentrate Using 2-Zone LBD with 3 Columns. (General Splitting Strategies 4)

The ligand bound sorbent is used to separate Nd/Pr and HREEs from a monazite concentrate. The composition and selectivities are listed in Table 23.

Table 23

Detailed REEs Composition in a Monazite Concentrate

| Elements | REE Mole fraction | Selectivity aᵢ,ᵢ₋₁ |
|---|---|---|
| La | 0.2399 | |
| Ce | 0.4435 | 3.7 |
| Pr | 0.0412 | 2.5 |
| Nd | 0.1559 | 1.8 |
| Sm | 0.0297 | 3.2 |
| Eu | 0.0009 | 1.5 |
| Gd | 0.0184 | 1.4 |
| Tb | 0.0009 | 4.2 |
| Y | 0.0459 | 1.9 |
| Dy | 0.0090 | 1.6 |
| Ho | 0.0009 | 2.6 |
| Er | 0.0044 | 1.8 |
| Tm | 0.0043 | 3.1 |
| Yb | 0.0042 | 1.8 |
| Lu | 0.0008 | 1.9 |

The composition and selectivity weighted composition factor of the grouped components are listed in Table 24.

Table 24

Mole Fractions and Selectivity Weighted Composition Factors in the Monazite Concentrate

| | Mole fraction (xᵢ) | Selectivity weighted composition factor (y_{L}) |
|---|---|---|
| La/Ce | 0.6834 | 0.1783 |
| Pr/Nd | 0.1971 | 0.0465 |
| HREEs | 0.1195 | 0.0351 |

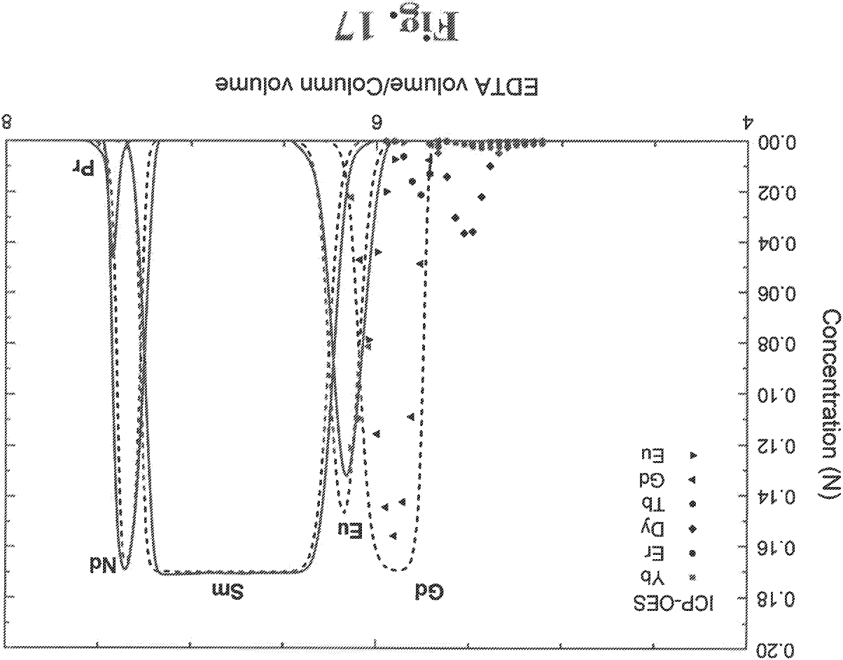

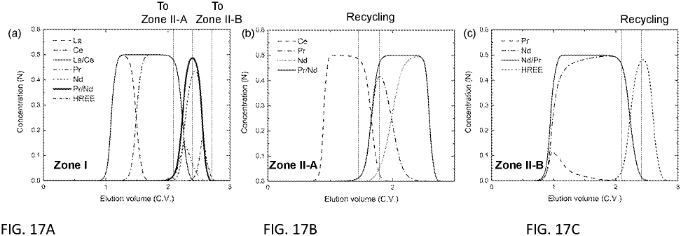

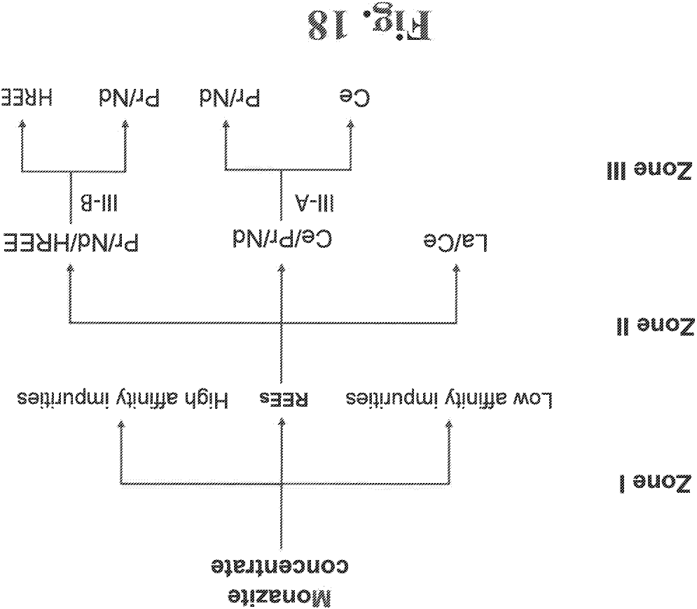

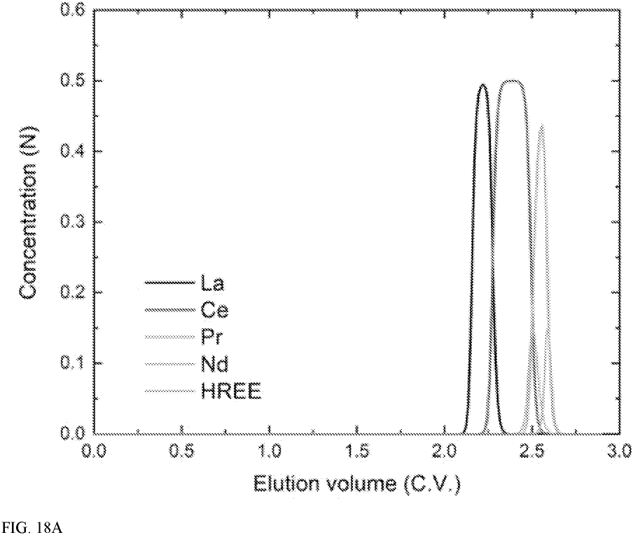

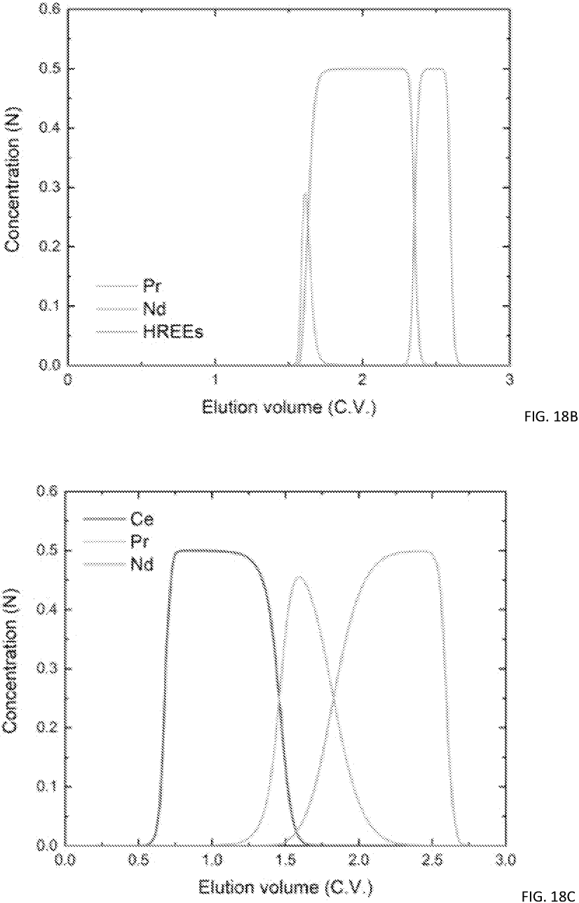

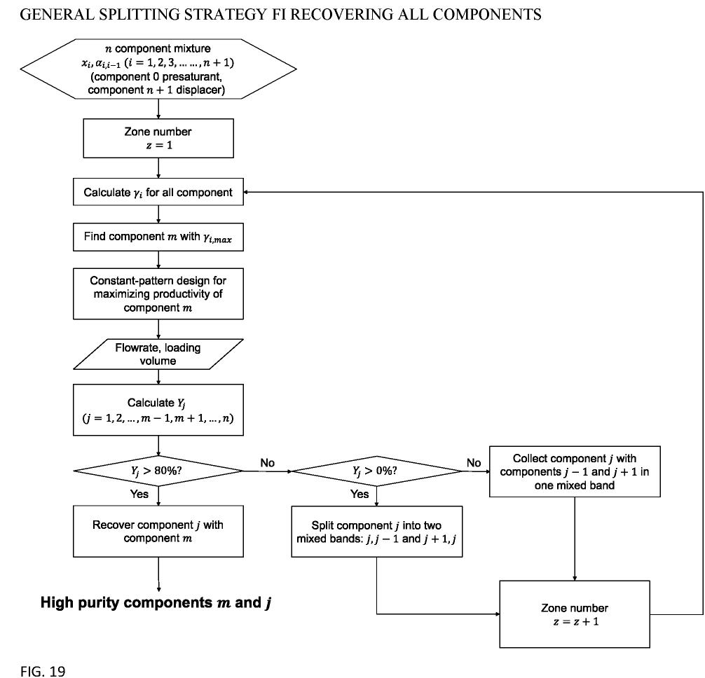

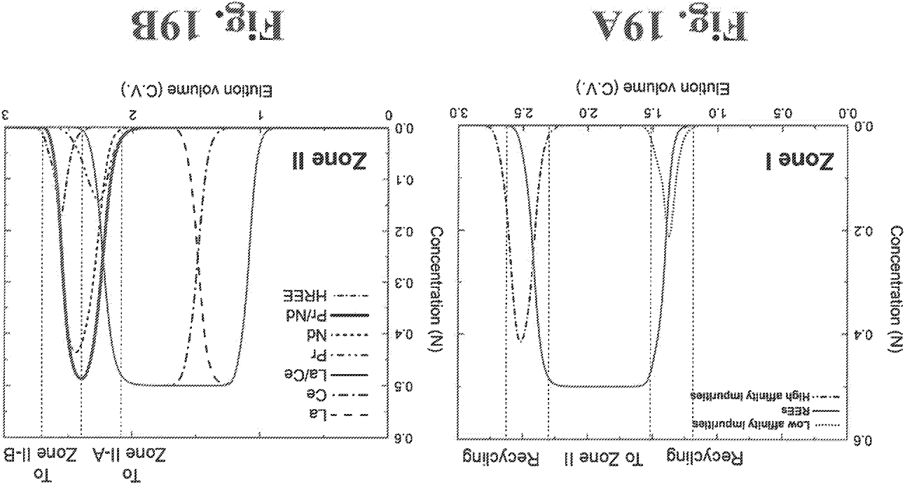

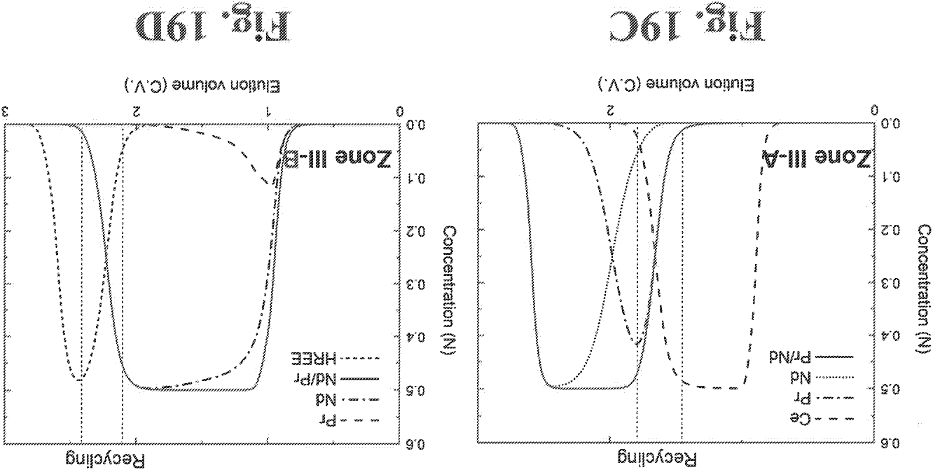

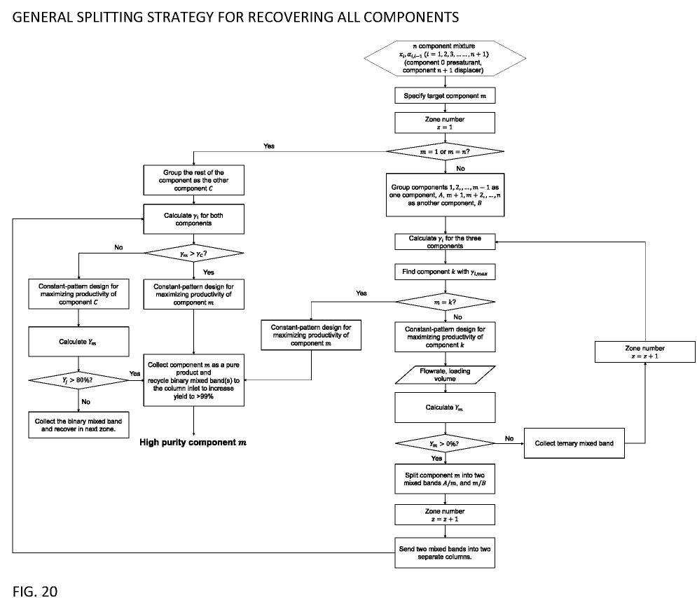

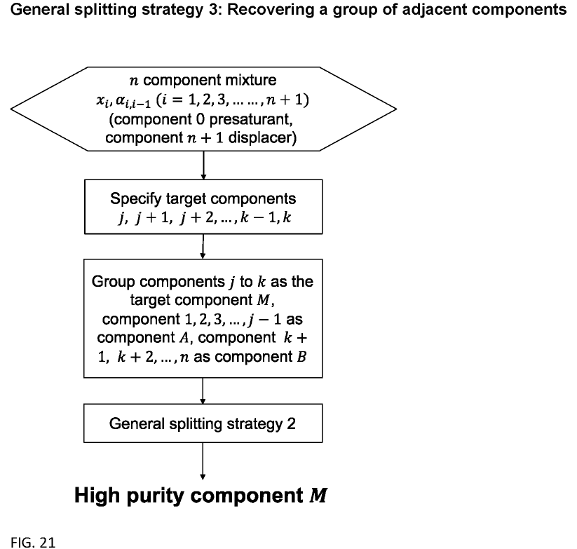

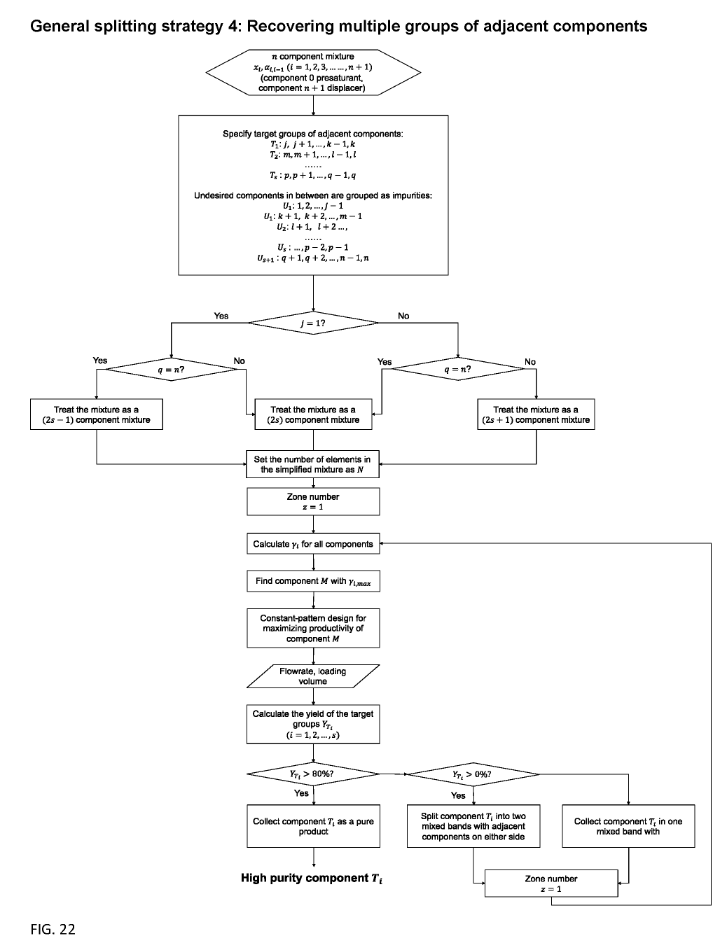

La and Ce are grouped as one component, Pr and Nd are grouped as the second component, and all the rest HREEs are grouped as the third component. The mixture is treated as a ternary mixture. To recover the two groups of adjacent components, (Pr/Nd) and HREEs, the general splitting strategy 4 is used. A two-zone LBD design with 3 columns is shown in FIG. 16

Since La/Ce has the highest _{γi} values among the three components, it is the target component in Zone I for maximizing the productivity. The grouped component, Pr/Nd, reaches the plateau concentration (FIG. 17A), indicating that the target product HREEs is almost completely separated from the impurity Ce/La. Therefore, the mixed band (Ce/Pr/Nd/HREEs) is split into two bands, (Ce/Pr/Nd) and (Pr/Nd/HREE). The two mixed bands are then sent to two columns in Zone II for further purification (FIGS. 17B-17C). The mixed band generated from each column in Zone II is recycled to the inlet of its respective column to improve the yield to >99%.

Table 25

Simulation Parameters for Example 4 Zone I

| L (cm) | | ID (cm) | | | R (µm) | | | ε_{b} | εₚ | Feed volume (ml) | | | Flow rate (ml/min) | Feed concentration (N) | | | |
|---|---|---|---|---|---|---|---|---|---|---|---|---|---|---|---|---|---|
| 100 | | 1 | | | 56 | | | 0.40 | 0.3 | 65.3 | | | 12.5 | La | | 0.2399 | |
| | | | | | | | | | | | | | | Ce | | 0.4435 | |
| | | | | | | | | | | | | | | Pr | | 0.0412 | |
| | | | | | | | | | | | | | | Nd | | 0.1559 | |
| | | | | | | | | | | | | | | HREE | | 0.0297 | |
| Isotherm Parameters (Constant Separation Factor Isotherm) | | | | | | | | | | | | | | | | | |
| qₘₐₓ = 1 meq./mL | | | | | | | | | | | | | | | | | |
| Component | | | | Separation factor | | | | | | | | | | | | | |
| 1 | Presaturant | | | 1 | | | | | | | | | | | | | |
| 2 | La | | | 5 | | | | | | | | | | | | | |
| 3 | Ce | | | 18.5 | | | | | | | | | | | | | |
| 4 | Pr | | | 46.25 | | | | | | | | | | | | | |
| 5 | Nd | | | 83.25 | | | | | | | | | | | | | |
| | | | | 266.4 | | | | | | | | | | | | | |
| 6 | Displacer | | | 1332 | | | | | | | | | | | | | |
| Mass Transfer Parameters | | | | | | | | | | | | | | | | | |
| Component | | | Brownian diffusivity, D_{b} (cm2/min) | | | | Pore diffusivity, Dₚ (cm²/min) | | | | Axial dispersion coefficient, E_{b} (cm2/min) | | | | Film mass transfer coefficient, k_{f} (cm/min) | | |
| All species | | | 4×10⁻⁴ | | | | 1× 10⁻⁴ | | | | Chung and Wen (1968) | | | | Wilson and Geankoplis (1966) | | |
| Numerical Parameters (Unit: N) | | | | | | | | | | | | | | | | | |
| Axial element | | | Step size (L/u₀) | | | Collocation points | | | | | | Tolerance | | | | | |
| | | | | | | Axial | | | Particle | | | Absolute | | | | | Relative |
| 151 | | | 0.01 | | | 4 | | | 2 | | | 1× 10⁻⁶ | | | | | 10⁻³ |

Table 26

Simulation Parameters for Example 4 Zone II-A

| L (cm) | | ID (cm) | | | R (µm) | | | ε_{b} | εₚ | Feed volume (ml) | | | Flow rate (ml/min) | Feed concentration (N) | | | |
|---|---|---|---|---|---|---|---|---|---|---|---|---|---|---|---|---|---|
| 100 | | 1 | | | 56 | | | 0.40 | 0.3 | 134.55 | | | 11.7 | Ce | | 0.222 | |
| | | | | | | | | | | | | | | Pr | | 0.096 | |
| | | | | | | | | | | | | | | Nd | | 0.181 | |
| Isotherm Parameters (Constant Separation Factor Isotherm) | | | | | | | | | | | | | | | | | |
| qₘₐₓ = 1 meq./mL | | | | | | | | | | | | | | | | | |
| Component | | | | Separation factor | | | | | | | | | | | | | |
| 1 | Presaturant | | | 1 | | | | | | | | | | | | | |
| 2 | Ce | | | 5 | | | | | | | | | | | | | |
| 3 | Pr | | | 12.5 | | | | | | | | | | | | | |
| 4 | Nd | | | 22.5 | | | | | | | | | | | | | |
| 5 | Displacer | | | 112.5 | | | | | | | | | | | | | |
| Mass Transfer Parameters | | | | | | | | | | | | | | | | | |
| Component | | | Brownian diffusivity, D_{b} (cm2/min) | | | | Pore diffusivity, Dₚ (cm²/min) | | | | Axial dispersion coefficient, E_{b} (cm2/min) | | | | Film mass transfer coefficient, k_{f} (cm/min) | | |
| All species | | | 4×10⁻⁴ | | | | 1× 10⁻⁴ | | | | Chung and Wen (1968) | | | | Wilson and Geankoplis (1966) | | |
| Numerical Parameters (Unit: N) | | | | | | | | | | | | | | | | | |
| Axial element | | | Step size (L/u₀) | | | Collocation points | | | | | | Tolerance | | | | | |
| | | | | | | Axial | | | Particle | | | Absolute | | | | | Relative |
| 151 | | | 0.01 | | | 4 | | | 2 | | | 1×10⁻⁵ | | | | | 10⁻³ |

Table 27

Simulation Parameters for Example 4 Zone II-B

| L (cm) | | ID (cm) | | | R (µm) | | | ε_{b} | εₚ | Feed volume (ml) | | | Flow rate (ml/min) | Feed concentration (N) | | | |
|---|---|---|---|---|---|---|---|---|---|---|---|---|---|---|---|---|---|
| 100 | | 1 | | | 56 | | | 0.40 | 0.3 | 227.2 | | | 16 | Pr | | 0.014 | |
| | | | | | | | | | | | | | | Nd | | 0.206 | |
| | | | | | | | | | | | | | | HREE | | 0.065 | |
| Isotherm Parameters (Constant Separation Factor Isotherm) | | | | | | | | | | | | | | | | | |
| qₘₐₓ = 1 meq./mL | | | | | | | | | | | | | | | | | |
| Component | | | | Separation factor | | | | | | | | | | | | | |
| 1 | Presaturant | | | 1 | | | | | | | | | | | | | |
| 2 | Ce | | | 5 | | | | | | | | | | | | | |
| 3 | Pr | | | 12.5 | | | | | | | | | | | | | |
| 4 | Nd | | | 22.5 | | | | | | | | | | | | | |
| 5 | Displacer | | | 112.5 | | | | | | | | | | | | | |
| Mass Transfer Parameters | | | | | | | | | | | | | | | | | |
| Component | | | Brownian diffusivity, D_{b} (cm2/min) | | | | Pore diffusivity, Dₚ (cm²/min) | | | | Axial dispersion coefficient, E_{b} (cm2/min) | | | | Film mass transfer coefficient, k_{f} (cm/min) | | |
| All species | | | 4×10⁻⁴ | | | | 1× 10⁻⁴ | | | | Chung and Wen (1968) | | | | Wilson and Geankoplis (1966) | | |
| Numerical Parameters (Unit: N) | | | | | | | | | | | | | | | | | |
| Axial element | | | Step size (L/u₀) | | | Collocation points | | | | | | Tolerance | | | | | |
| | | | | | | Axial | | | Particle | | | Absolute | | | | | Relative |
| 151 | | | 0.01 | | | 4 | | | 2 | | | 1× 10⁻⁶ | | | | | 10⁻³ |

While the novel technology has been illustrated and described in detail in the drawings and foregoing description, the same is to be considered as illustrative and not restrictive in character. It is understood that the embodiments have been shown and described in the foregoing specification in satisfaction of the best mode and enablement requirements. It is understood that one of ordinary skill in the art could readily make a nigh-infinite number of insubstantial changes and modifications to the above-described embodiments and that it would be impractical to attempt to describe all such embodiment variations in the present specification. Accordingly, it is understood that all changes and modifications that come within the spirit of the novel technology are desired to be protected.

We claim:

1. A process of separating and isolating substantially pure (95% or greater) N mixed rare earth elements (REEs), comprising:
a) dissolving a mixture containing N different REEs to yield N different REE ions in solution;
b) in a (N-(N-1)th zone, separating out substantially pure first and second REEs and segregating a first mixed band of first and second REEs from a second mixed band of second through N Rees;
c) sending first mixed band to a second zone in a first column and sending second mixed band to a second zone in a second column;
d) in (N-(N-2))th zone in first column, separating out substantially pure first and second REEs and in (N-(N-2))th zone in second column, segregating a third mixed band of second and third REEs from a fourth mixed band of third through N REEs;
e) sending third mixed band to third zone in first column and sending fourth mixed band to third zone in second column;
f) in (N-(N-3))th zone in first column, separating out substantially pure second and third REEs and in (N-(N-3))th zone in second column, segregating a fifth mixed band of third and fourth REEs from a sixth mixed band of fourth through Nth REEs;
g) repeat the above steps until N bands of different respective REEs are formed and segregated from one another.

2. The process of claim 1 wherein separation occurs through LAD.

3. A process of separating and isolating substantially pure rare earth elements (REEs) comprising:
h) dissolving a mixture containing four different REEs to yield four different REE ions in solution;
i) in a first zone, separating out substantially pure first and second REEs and segregating a first mixed band of first and second REEs from a second mixed band of second through fourth REEs;
j) sending first mixed band to a second zone in a first column and sending second mixed band to a second zone in a second column;
k) in second zone in first column, separating out substantially pure first and second REEs and in second zone in second column, segregating a third mixed band of second and third REEs from a fourth mixed band of third and fourth REEs;
1) sending third mixed band to third zone in first column and sending fourth mixed band to third zone in second column;
m) in third zone in first column, separating out substantially pure second and third REEs and in third zone in second column, separating out substantially pure third and fourth REEs.

4. The process of claim 3 wherein before i), each zone is filled with a presaturant.

5. The process of claim 4 wherein separation of elements occurs through the introduction of ligands in each respective zone that have respective selective affinities for the respective elements.

6. The process of claim 5 and further comprising: introducing a displacer into the respective bands to elute respective rare earth elements.

7. The process of claim 6 wherein the ligands are selected from the group comprising ethylenediaminetetraacetic acid include citric acid, ethylenediaminetetraacetic acid (EDTA), diethylenetriaminepentaacetic acid (DTPA), nitrilotriacetic acid (NTA), bicine, HDEHP, DGA, and combinations thereof; wherein the presaturant is selected from the group comprising copper, sodium, and erbium; and wherein the displacer is hydrogen.

8. A method for separating substantially pure rare earth metals and other metals from a mixed source, comprising:
a) putting a plurality of rare earth metals and other metals into solution to define a solution containing a plurality of respective metal ions;
b) in at least one chromatographic column, selectively capturing ions of each respective metal with a respective ligand to define a plurality of respective discrete bands; and
c) respectively eluting captured ions of respective metal from each respective band of the at least one chromatographic column to yield a plurality of purified solutions, each respective purified solution having a high concentration of a respective metal.

9. The method of claim 8 and further comprising:
d) before a), filling the at least one chromatographic column with at least one presaturant, wherein the at least one presaturant is a solution containing ions selected from the group comprising: copper ions, sodium ions, erbium ions, and combinations thereof.

10. The method of claim 8, wherein the respective ligands are selected from the group comprising ethylenediaminetetraacetic acid include citric acid, ethylenediaminetetraacetic acid (EDTA), diethylenetriaminepentaacetic acid (DTPA), nitrilotriacetic acid (NTA), bicine, HDEHP, DGA, and combinations thereof.

11. The method of claim 8, wherein each respective zone contains the same ligand, and wherein each respective band has a different concentration of the same ligand.

12. The method of claim 8, wherein the respective metals are eluted by establishing a pH gradient in the at least one chromatographic column.

13. The method of claim 12 wherein the pH gradient is a stepwise gradient.

14. The method of claim 8, wherein the plurality of discrete bands move through the at least one chromatographic column.

15. The method of claim 8 wherein the plurality of discrete bands are fixed within the at least one chromatographic column.

16. The method of claim 8 wherein the metals are eluted through the introduction of a hydrogen displacer.

17. The method of claim 16 wherein the hydrogen displacer enjoys a different concentration in each band.
